(19) United States
(12) Patent Application Publication
(10) Pub. No.: US 2002/0046139 A1
(43) Pub. Date: Apr. 18, 2002

(54) Commerce information distribution system and commerce information managing method

(75) Inventors: Toru Ozaki, Kawasaki (JP); Makoto Yoshioka, Kawasaki (JP); Hidefumi Aoe, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 09/933,766

(22) Filed: Aug. 22, 2001

(30) Foreign Application Priority Data
Aug. 25, 2000 (JP) 2000-255713

(51) Int. Cl. G06F 17/60

(52) U.S. Cl. 705/27

(57) ABSTRACT

A commerce out-sourcing center generates a CM broadcast and CM information relating to the CM broadcast according to commerce information at a request from a merchandise producer or a service provider, and requests a broadcasting station to broadcast the CM broadcast and CM information. A client receives the CM broadcast from the broadcasting station by the broadcast reception terminal device, and selects merchandise or a service to be purchased from the CM information relating to the CM broadcast. At this time, the information about the merchandise, etc., the CM broadcast designation information indicating through which CM broadcast the client purchases the merchandise or the service, etc., the information about the client, etc. are transmitted as commerce information from a broadcast reception terminal device to the computer of the commerce out-sourcing center through a portable terminal device and a terminal device of a retail shop.

### BACKGROUND OF THE INVENTION

1. Field of the Invention

The present invention relates to a commerce information distribution system capable of distributing commerce information among media and companies, and realizing effective commerce according to well-managed commerce information by collectively managing commerce information such as CM information, merchandise or service information, client information, etc. independently distributed for each company.

2. Description of the Related Art

There have been a number of commerce systems using commercials independently for each medium and merchandise producers and service providers.

For example, in the commerce systems using Internet, a merchandise producers or a service provider opens a Web site on which merchandise is sold or a service is provided through Internet which is referred to as an Internet shop. In the Internet shop, the CM contents are shown to sell merchandise or provide a service. A consumer can be connected to Internet to access a Web site of the Internet shop, and buy desired merchandise or request a desired service. Some Internet shops provides incentives such as reduction points, etc. each time a consumer buys merchandise, and gives a service of a gift certificate, a book certificate, etc. when a total number of points reaches a predetermined value. Purchased merchandise is delivered directly to the consumer, or delivered to a retail store such as a convenience shop, etc. through which the consumer obtains the merchandise.

In the commerce system through TV, radio, and movies, a commercial is presented relating merchandise and services, which will interest consumers. In the commerce system through newspapers and magazines, CM contents relating to merchandise and services, which will interest consumers, are presented to consumers in newspapers and magazines. For example, if a consumer sees (hears) these CM broadcast and CM contents, decides to purchase merchandise if the consumer is interested in it, and either directly goes to a shop where they sell the merchandise, or uses an Internet shop to buy the merchandise.

In the commerce system using a data broadcasting, CM information is broadcast using a ground wave TV broadcasting and a satellite broadcasting relating to merchandise and services, which will interest consumers. For example, in the digital broadcasting, a data-broadcasting channel for transmission of information is independently provided in addition to the main programs and CM broadcast of images and voice. Using the data broadcasting, CM information such as shopping information, etc. relating to the main programs and CM broadcast is broadcast. For example, a consumer sees the CM information, decides to buy desired merchandise, and either directly goes to a shop where they sell the merchandise, or uses an Internet shop to buy the merchandise. Although a data broadcasting is a one-way communication from a broadcasting station to a consumer, a two-way communication through which a consumer can be directly linked to an Internet shop, etc. can be realized by generating CM information on the form which can access the internet , and receiving the information through a terminal connectable to Internet.

Those merchandise and services presented in the CM contents, the CM broadcast and the CM information have been selected if they possibly interest a large number of consumers according to a questionnaire, etc. independently issued by a merchandise producer or a service provider.

Furthermore, since a broadcast program for a CM broadcast and CM information is fixed and costly, merchandise or a service to be advertised by the CM broadcast and the CM information is limited to those having a sufficient advertising effect within a limited broadcast program. Therefore, the contents of a commercial are determined in advance.

However, since the commerce system using such commercials is independent of each company, that is, a merchandise producer or a service provider, the commerce information distributed in a commerce system of each company is independently prepared for each company, and is not distributed among companies. Therefore, the information referred to when a company checks the tendency of the taste of consumers is limited to the results of a questionnaire issued by the company, the purchase information, etc. about consumers which has been stored by the company. Therefore, the tendency of the taste of consumers obtained from the check is limited to a small range, is not effective, or does not show detailed tendency of the taste of the consumers. Therefore, the optimum merchandise or service to be advertised in the CM contents, CM broadcast, and CM information cannot be selected. As a result, there has been the problem that an effective advertisement cannot be prepared.

On the other hand, since a broadcast program for the CM broadcast and the CM information to be broadcast through TV, radio, movies, a data broadcasting is fixedly purchased for a predetermined period by an advertiser company from a broadcasting company, the broadcast program is not changed during the broadcast period. Furthermore, since merchandise or a service in a CM broadcast and CM information are determined in advance before the broadcast, it is not changed into another merchandise or service during the broadcast. Additionally, there has not been a system of using on the spot a broadcast program of a CM broadcast and CM information with the sales information about a company, inventory information, etc. Therefore, for example, there has been the problem that when merchandise being advertised in the CM broadcast and in the CM information is running short, or the sales of the merchandise increase, etc., the broadcast program of the CM broadcast and the CM information cannot be changed, or the contents of the broadcast of the CM broadcast and the CM information cannot be flexibly changed into another merchandise, thereby failing in performing an effective advertising process.

Furthermore, when a consumer who sees (hears) the URL of an Internet shop requests to purchase merchandise or receive a service through an Internet shop, the consumer has to access the URL by himself or herself. Therefore, the consumer has to bear the communication rate (telephone rate, etc.) required to access it.

When consumer purchases merchandise through an Internet shop, a convenience store, etc. is used as a place where the consumer can receive the purchased merchandise. However, some types of merchandise require aftercare, but there is no staff having sufficient knowledge about the merchandise at a convenience store, etc. Therefore, the consumer cannot receive the necessary aftercare.

### SUMMARY OF THE INVENTION

The present invention has been developed to solve the above mentioned problems, and aims at providing a commerce information distribution system capable of distributing commerce information among media and companies, and realizing more effective commerce according to well-managed commerce information by collectively managing the commerce information which has been independently distributed for each company.

The commerce information distribution system according to a first aspect of the present invention includes: a commerce out-sourcing center having a computer for managing commerce information for receiving a request to generate a CM broadcast and CM information relating to the CM broadcast from at least one of a merchandise producer and a service provider; a broadcasting station broadcasting the CM broadcast and the CM information relating to the CM broadcast generated according to the commerce information; and a terminal transmitting CM broadcast designation information designating at least the CM broadcast as commerce information to the commerce outsourcing center when a client sees the CM broadcast and purchases merchandise or a service according to the CM information relating to the CM broadcast.

With the above mentioned configuration, the commerce out-sourcing center can obtain the information as to whether or not the client has seen or heard any CM broadcast and has purchased the merchandise or service, thereby generating a more effective CM broadcast and the CM information relating to the CM broadcast. As a result, a more effective advertising process can be performed.

A commerce information management apparatus according to the second aspect of the present invention includes: a CM information generation unit generating a CM broadcast according to managed commerce information and CM information relating to the CM broadcast after receiving a request from a merchandise producer or a service provider; a request unit requesting a broadcasting station to broadcast the CM broadcast and the CM information relating to the CM broadcast; and a management unit receiving CM broadcast designation information designating at least a CM broadcast seen by a client from a terminal used by the client when the client purchases merchandise or a service according to the CM information relating to the CM broadcast after the client sees the CM broadcast, and managing the CM broadcast designation information as the commerce information.

With the configuration, the commerce information which has been distributed independently for each merchandise producer or service provider can be collectively managed by the commerce information management apparatus, and a more effective CM broadcast and CM information relating to the CM broadcast can be generated according to the managed commerce information.

The commerce information management apparatus according to the third aspect of the present invention includes: a first reception unit receiving information about merchandise or a service upon receipt of a request from a merchandise producer or a service provider; a second reception unit receiving information about a client or CM information about merchandise of a service as commerce information when the client purchases the merchandise or the service; and a management unit collectively managing the commerce information.

With the above mentioned configuration, the commerce information management apparatus can manage the information about merchandise or a service, the information about a client, and the CM information about the merchandise or the service with these pieces of information associated with one another.

### BRIEF DESCRIPTION OF THE DRAWINGS

The present invention will be more apparent from the following detailed description when the accompanying drawings are referenced.

FIG. 1 shows the concept of the commerce information distribution system according to the first embodiment of the present invention;

FIG. 2 shows an example of the database structure of a DB;

FIG. 3 shows an example when the data of merchandise A expressed in the XML data format;

FIG. 4 is a flowchart according to the first embodiment of the present invention;

FIG. 5 is a flowchart of selecting merchandise by a client;

FIG. 6A shows an example of a display screen on which CM information is displayed;

FIG. 6B shows an example of a display screen on which CM information is displayed;

FIG. 7 shows an example of a display screen on which a merchandise catalog is displayed;

FIG. 8 shows an example describing a merchandise catalog in an XML data format;

FIG. 9 shows an example of a display screen on which recommended merchandise is displayed;

FIG. 10 shows an example of a display screen on which a price and a function are classified;

FIG. 11 is a flowchart of selecting ‘1. selection by price’;

FIG. 12 shows an example of a display screen displayed when ‘4. selection by referring to all tables’ on the display screen of classification by price/function;

FIG. 13 shows an example of merchandise information transmitted to a portable terminal device;

FIG. 14 shows an example of purchase information;

FIG. 15 shows the configuration of the hardware of the broadcast reception terminal device;

FIG. 16A shows the configuration of the hardware when a portable terminal device is a portable telephone;

FIG. 16B shows the configuration of the hardware when a portable terminal device is a smart card;

FIG. 17 is a flowchart according to the second embodiment of the present invention;

FIG. 18 is a flowchart according to the third embodiment of the present invention;

FIG. 19 is a flowchart according to the fourth embodiment of the present invention;

FIG. 20 is a flowchart according to the fifth embodiment of the present invention; and

FIG. 21 is a flowchart of the authenticating process according to the fifth embodiment of the present invention.

### DESCRIPTION OF THE PREFERRED EMBODIMENT

The embodiments of the present invention are described below by referring to the attached drawings.

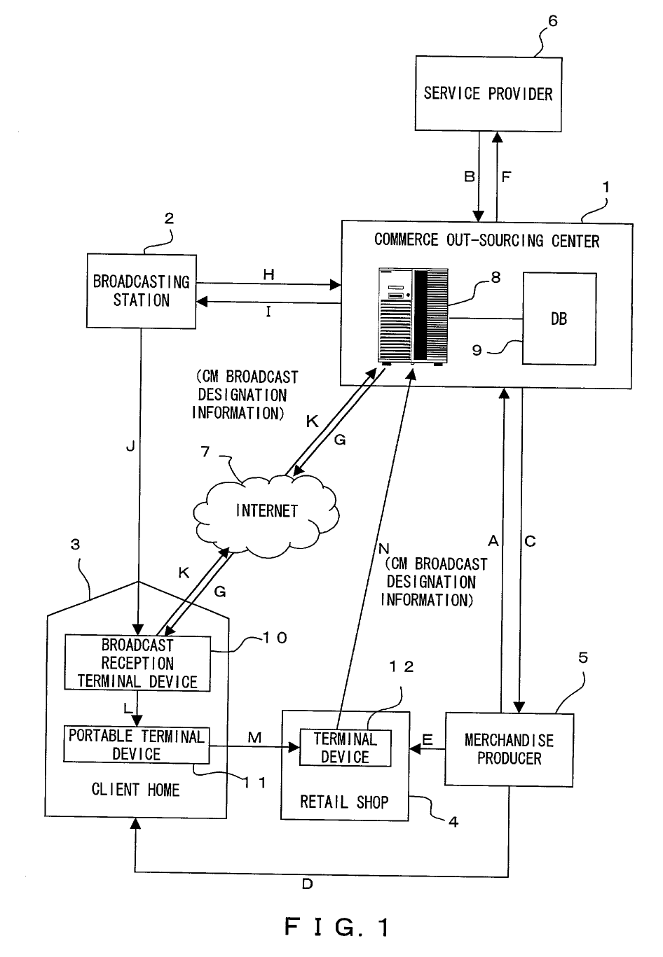

FIG. 1 shows the concept of the commerce information distribution system according to the first embodiment of the present invention. As shown in FIG. 1, the commerce information distribution system according to the present embodiment comprises a commerce out-sourcing center 1, a broadcasting station 2, a client home 3, a retail shop 4, a merchandise producer 5, a service provider 6, a Internet 7, etc. In FIG. 1, there are the broadcasting station 2, the client home 3, the retail shop 4, the merchandise producer 5, and the service provider 6 in one unit for simple explanation. However, some of them are practically mounted in plural units.

The merchandise producer 5 is a company which produces merchandise. For example, it can be a manufacturer, etc. The service provider 6 is a company which provides a service. For example they can be a deliverer, a mover, etc. who provide a service of delivering things. The merchandise producer 5 and the service provider 6 request the commerce out-sourcing center 1 to generate a CM broadcast and CM information relating to the CM broadcast (arrows A and B). The merchandise producer 5 delivers ordered merchandise directly to the client home 3 (arrow D) or temporarily to the retail shop 4 (arrow E) where the client receives the merchandise based on the contents (arrow C) of the request from the client transmitted through the commerce out-sourcing center 1. The service provider 6 provides an ordered service based on the ordered contents (arrow F) of the client transmitted through the commerce out-sourcing center 1.

The commerce out-sourcing center 1 comprises a computer 8 and a database (hereinafter referred to simply as DB) 9, and manages the commerce information transmitted from the broadcasting station 2, the client home 3, the retail shop 4, the merchandise producer 5, the service provider 6, etc.

The commerce information refers to the information about a broadcast program purchased from the broadcasting station 2, the information about merchandise or a service transmitted from the merchandise producer 5 or the service provider 6, the CM broadcast designation information indicating through which CM broadcast a client has purchased merchandise or a service, the information about the merchandise or a service purchased by a client, the usability information, request information, claim information, and improvement suggestion information about the merchandise or a service purchased by the client, the information about a client including the attribute data such as the age, sex, family, etc. of a client, the information about the merchandise inventory situation of the merchandise producer 5, the information (service providing information) about the service providing ability of the service provider 6, and various aggregate data obtained from the information above.

The above mentioned commerce information is entered in the DB 9 and managed by a computer 8.

The commerce out-sourcing center 1 either transmits the analysis result obtained by analyzing the data of the commerce information in a data mining process, etc. to the merchandise producer 5 or the service provider 6 (arrows C and F), or uses it in the commerce out-sourcing center 1. The computer 8 is connected to Internet 7 and transmits the information about the merchandise or a service in which a client is interested according to the commerce information to a broadcast reception terminal device 10 of the client home 3 through Internet 7 (arrow G). The commerce out-sourcing center 1 purchases a broadcast program from the broadcasting station 2 (arrow H), or requests the broadcasting station 2 to broadcast (arrow I) a generate CM broadcast and the CM information relating to the CM broadcast. Furthermore, based on the order of a client, the ordered contents are transmitted to the merchandise producer 5 or the service provider 6 (arrows C and F).

The broadcasting station 2 provides a digital broadcasting, and broadcasts, for example, main programs such as news, sports, quiz, etc., CM broadcasts, added information, etc. relating to the main programs and CM broadcasts using a data broadcasting.

The client home 3 is provided with the broadcast reception terminal device 10 for receiving a digital broadcasting (arrow J) to be broadcast from the broadcasting station 2. The broadcast reception terminal device 10 is connected to Internet 7, and can order merchandise or a service in the commerce out-sourcing center 1 through Internet 7 based on the broadcast CM broadcast. The broadcast reception terminal device 10 transmits CM broadcast designation information indicating through which CM broadcast a client has placed an order to the commerce out-sourcing center 1 (arrow K). Furthermore, the broadcast reception terminal device 10 can transmit or receive data to or from a portable terminal device 11 owned by a client, and can output to the portable terminal device 11 the information about merchandise, a service, etc. which a client requests to purchase (arrow L). The portable terminal device 11 is a terminal portable by a client such as a portable telephone, a PHS, a PDA, a smart card, etc.

The broadcast reception terminal device 10 and the portable terminal device 11 store the information about a client including a client identification number identifying a client, the age, sex, family, etc. of the client. The client identification number identifies an owner.

The retail shop 4 is, for example, a convenience store, etc. and comprises a terminal device 12 communicable with the commerce outsourcing center 1 through a communications line. The terminal device 12 can also transmit or receive data to or from the portable terminal device 11 owned by a client, and can output from the portable terminal device 11 to the terminal device 12 the merchandise or the service which a client requests to purchase (arrow M). The information about the merchandise or the service, etc. which the client requests to purchase is transmitted from the terminal device 12 to the computer 8 of the commerce out-sourcing center 1 with the CM broadcast designation information indicating through which CM broadcast the client has ordered the merchandise or a service when the client orders the merchandise or the service in the retail shop 4 (arrow N). When a client directly visits the retail shop 4 and purchases merchandise, the retail shop 4 can obtain the CM broadcast designation information.

The transmission and reception of data between the broadcast reception terminal device 10 and the portable terminal device 11, and between the portable terminal device 11 and terminal device 12 are performed through short distance wireless communications such as the bluetooth and infrared ray communications and a transceiver mode of a PHS, etc. Furthermore, the communications between the client home 3 and the retail shop 4 and the commerce out-sourcing center 1 are not limited to the embodiment shown in FIG. 1.

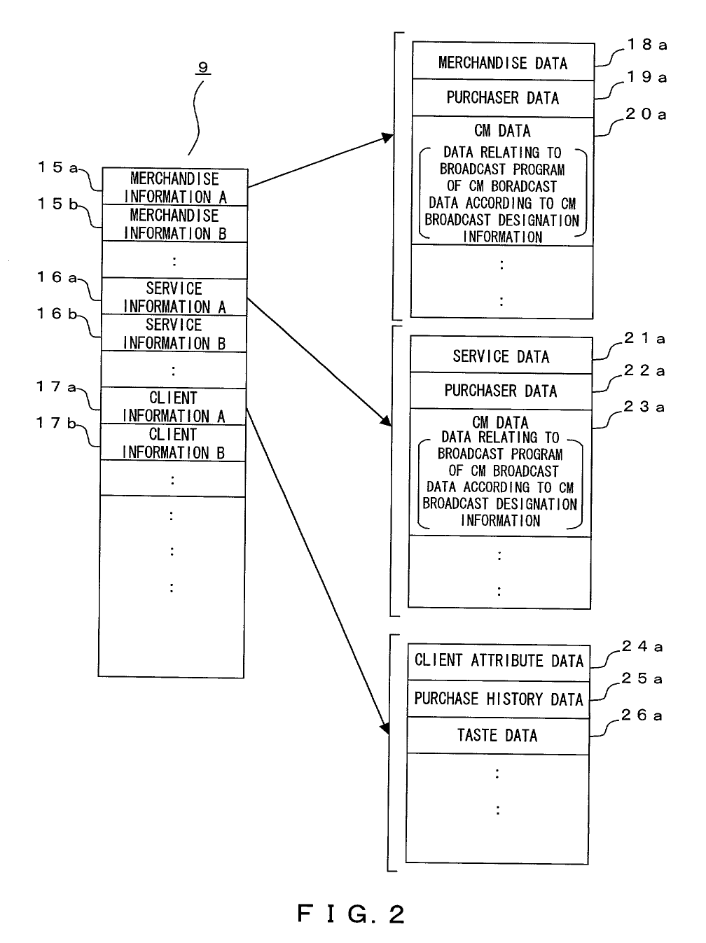

FIG. 2 shows an example of the database structure of the DB 9. As shown in FIG. 2, the DB 9 stores the commerce information such as merchandise information 15, service information 16, client information 17, etc. according to the commerce information obtained from the merchandise producer 5, the service provider 6, the client home 3, the retail shop 4, etc.

Each piece of merchandise information 15 comprises merchandise data 18, purchaser data 19, CM data 20, etc. for each pieces of merchandise (merchandise A, merchandise B, . . . ). In this example, the merchandise information A 15a about the merchandise A is described. The merchandise data 18a relates to the merchandise A, and includes the data such as a merchandise name, a merchandise number, a price, a characteristic, etc. of the merchandise A, the information about the merchandise inventory of the merchandise A, the information about the sales of the merchandise A, and the information about the answer result of the questionnaire about the merchandise A, etc. For example, the data is described in the XML data format with the easiness in transmission and reception of data taken into account.

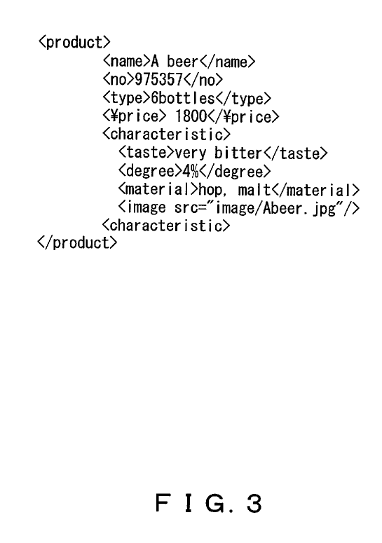

FIG. 3 shows an example of describing a part of the merchandise data 18 in the XML data format. The merchandise data 18 shown in FIG. 3 describes as an example, the merchandise name (name), the merchandise number (no), the type (type), the price (price), and the characteristic (characteristic) of the merchandise ‘A beer’. The characteristic(characteristic) is expressed by taste(taste), degree of alcohol(degree), material(material), and image(image).

Back in FIG. 2, the purchaser data 19a of the merchandise information A 15a includes the aggregate data of the age, sex, area, hobby, etc. of a person who has purchased the merchandise A. The CM data 20a includes the data about the broadcast program of the CM broadcast provided with the CM information about the merchandise A, the aggregate data of the number of purchasers who purchased the merchandise A by CM broadcast, the aggregate data by CM broadcast time period, the aggregate data by main programs (news, sports, drama, quiz, etc.) provided when CM broadcast is realized based on the CM broadcast designation information indicating through which CM broadcast a client has purchased the merchandise A. The data about the broadcast program of the CM broadcast provided with the CM information includes the cost of the broadcast program purchased from the broadcasting station 2, the broadcast time of the CM broadcast and the CM information relating to the CM broadcast.

Furthermore, each piece of service information 16 includes service data 21, purchaser data 22, CM data 23, etc. for each service (service A, service B, . . . ). In this example, the service information A 16a about the service A is described. The service data 21a is the data about the service A, and includes the data such as the service name, service number, price, characteristic, etc. of the service A, the information about the service providing capability of service A, the information about the sales of the service A, the information about the answer result of the questionnaire of the service A. For example, the data is described in the XML data format with the easiness in transmission and reception taken into account.

The purchaser data 22a includes the aggregate data by attribute such as by age, sex, area, hobby, etc. of the person who purchases the service A, and the CM data 23a includes the data about the broadcast program of the CM broadcast provided with the CM information about the service A, the aggregate data of the number of purchasers who purchased the service A by CM broadcast, the aggregate data by CM broadcast time period, the aggregate data by main programs provided when CM broadcast is realized according to the CM broadcast designation information. The data about the broadcast program of the CM broadcast provided with the CM information includes the cost of the broadcast program purchased from the broadcasting station 2, the broadcast time of the CM broadcast and the CM information relating to the CM broadcast.

Each piece of client information 17 includes client attribute data 24, purchase history data 25, taste data 26, etc. for each client (client A, client B, . . . ). In this example, client information A 17a about the client A is described. The client attribute data 24a includes the client identification number, name, age, sex, address, hobby, family, etc. of the client A. The client attribute data 24a is entered when the client A makes a contract directly with the commerce outsourcing center 1 or when the client purchases merchandise or a service. When the client makes a contract with the commerce out-sourcing center 1, an incentive of a service point, etc. is assigned to the client. The purchase history data 25a includes the merchandise number of merchandise previously purchased, the service number of a service, the accumulated data of the service points assigned when a client purchases merchandise or a service through a CM broadcast, etc. The taste data 26 includes the taste data, etc. of the client a obtained based on the purchase history data 25a.

Otherwise, the DB 9 stores the aggregate data of the number of clients who purchases merchandise or a service by CM broadcast, the aggregate data of the number of clients who purchases merchandise or a service by CM broadcast time period, the aggregate data of the number of clients who purchases merchandise or a service by main program when a CM broadcast is performed, etc. according to the merchandise information 15, the service information 16, the client information 17, etc. It also stores a broadcast program purchased from the broadcasting station 2, the cost of purchasing the broadcast program, the budget relating to the request to prepare a CM broadcast and the CM information relating to the CM broadcast presented by the merchandise producer 5 or the service provider 6, etc.

Described below is the flow of the commerce information according to the present embodiment.

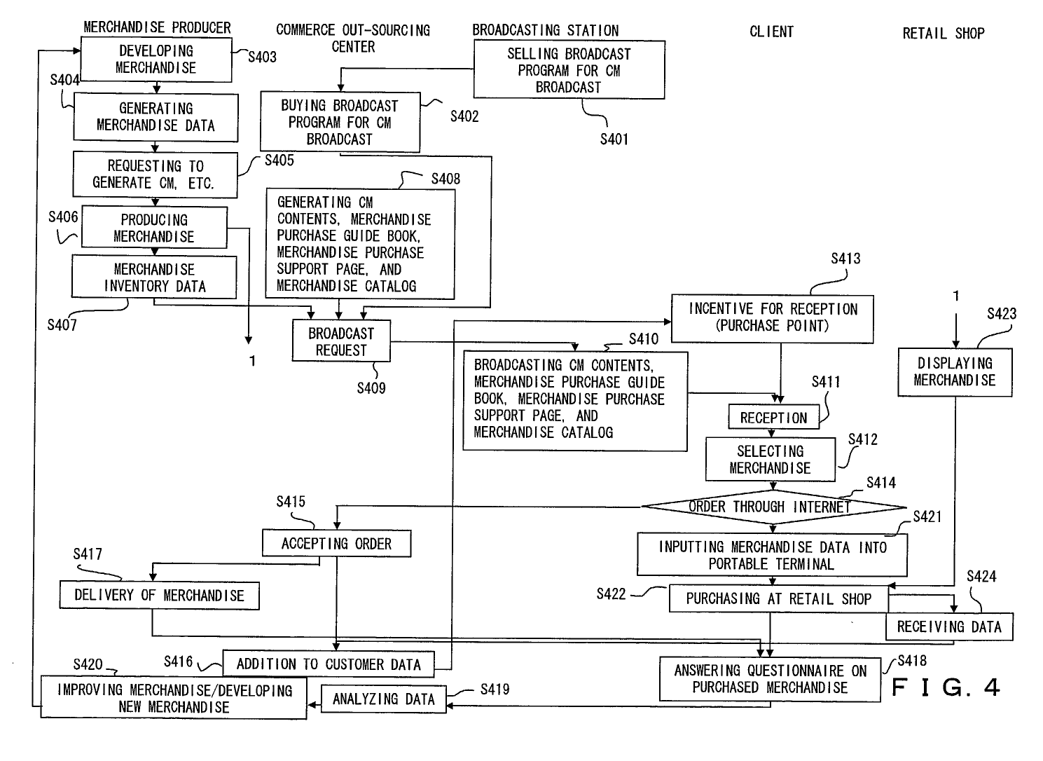

FIG. 4 is a flowchart according to the first embodiment of the present invention. FIG. 4 shows the flow of the commerce information in the commerce out-sourcing center 1, the broadcasting station 2, a client, and the retail shop 4. In this example, the flow of the commerce information about merchandise is mainly explained, but the present invention is not limited to this flow, and the flow of the commerce information about a service is similarly processed.

As shown in FIG. 4, the broadcasting station 2 sells the broadcast program of a CM broadcast to reserve the budget of broadcasting main programs (step (hereinafter referred to simply as S) 401).

The commerce out-sourcing center 1 purchases in advance a broadcast program of a CM broadcast put for sale (S402) On the other hand, when the merchandise producer 5 develops a new product (S403), it generates merchandise data for advertisement to promote the sales of the new product (S404). The merchandise data is described in, for example, the XML data. Then, it requests the commerce outsourcing center 1 to generate a CM broadcast, CM information relating to the CM broadcast, etc., and presents the budget, the merchandise data required when the request is issued (S405). Then, the merchandise producer 5 starts producing a new product (S406), and delivers the produced product to the retail shop 4. The retail shop 4 displays the delivered product in the shop (S423). The merchandise producer 5 also transmits the merchandise inventory data to the commerce outsourcing center 1 (S407).

Upon receipt of the request from the merchandise producer 5, the commerce out-sourcing center 1 enters the merchandise data transmitted from the merchandise producer 5 in the merchandise information 15 in the DB 9, and generates CM contents which is a CM broadcast, the merchandise catalog, a merchandise purchase guide book, a merchandise purchase support page, etc. which is CM information relating to the CM broadcast from the merchandise data (S408). The merchandise catalog is merchandise listing information. The merchandise purchase guide book contains the information classified by the characteristic of merchandise. The merchandise purchase support page contains the information supporting the purchase of merchandise according to the merchandise purchase guide book. By obtaining the above mentioned CM information, the client can quickly be informed of the merchandise, have a wide selection range of merchandise and services, and select desired merchandise within a short time.

A CM broadcast and the CM information relating to the CM broadcast can be generated by the commerce out-sourcing center 1 requesting an external company to generate it.

In this example, the case in which a requester is the merchandise producer 5 is described. When a requester is the service provider 6, a service catalog, a service purchase guide book, a service purchase support page, etc. are generated. The service catalog is a service listing information, a service guide gook contains information classified by the characteristic of a service, and a service purchase support page contains information for support of the purchase of services based on the service guide book.

Then, according to the broadcast program for a CM broadcast purchased in S402, the merchandise inventory data transmitted from the merchandise producer 5 in S407, and the commerce information, etc. stored in the DB 9, the most effective broadcast program is selected and determined. Using the determined broadcast program, the broadcasting station 2 is requested to broadcast the CM broadcast and the CM information relating to the CM broadcast of merchandise generated in S408 (S409).

The commerce information referred to when the broadcast program is selected contains, for example, the aggregate data of the number of clients who purchases merchandise by CM broadcast, the aggregate data by CM broadcast time period, the aggregate data by main program (news, sports, drama, quiz, etc.) for a CM broadcast, etc. contained in the merchandise information 15 about similar type of merchandise. These pieces of commerce information is based on the CM broadcast designation information indicating through which CM broadcast a client has purchased merchandise, and the optimum broadcast program having a higher advertising effect can be determined.

The broadcasting station 2 broadcasts a CM broadcast and CM information relating to the CM broadcast together with the main program at a request from the commerce out-sourcing center 1 (S410).

A client receives broadcasts by the broadcast reception terminal device 10 at the client home 3 (S411).

According to the present embodiment, when a client purchases merchandise or a service through a CM broadcast, a service point is assigned to the client for incentive (S413). For example, when accumulated points reach a predetermined value of points, various privileges such as a discount from an Internet communications fee, a digital broadcasting reception fee, a telephone fee, etc. are assigned to a client. Otherwise, a client can purchase merchandise or a service through a CM broadcast free of Internet communications fee, digital broadcasting reception fee, telephone fee, etc. Thus, by assigning an incentive to a client, the client tends to see the CM broadcast more frequently, thereby improving the advertising effect on merchandise. Furthermore, the point assigning system set for each of the merchandise producers 5 or the service providers 6 can be collectively managed by the commerce out-sourcing center 1, thereby setting a point assigning system in a wider range. Furthermore, the load to the merchandise producer 5 or the service provider 6 in each point assigning system can be suppressed.

The client operates, for example, a remote controller to display CM information relating to a CM broadcast on the broadcast reception terminal device 10 and select merchandise if there is a CM broadcast of merchandise to be purchased in the CM broadcast being broadcast (S412).

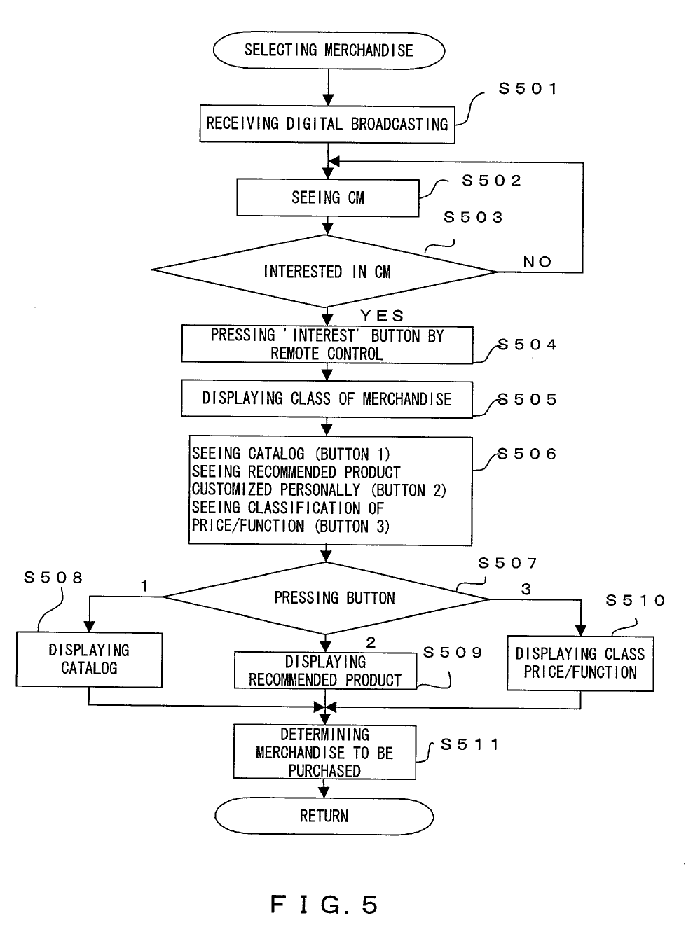

FIG. 5 is a flowchart of the selection of merchandise of a client (S412 shown in FIG. 4). As shown in FIG. 5, the client receives a digital broadcasting from the broadcasting station 2 (S501 shown in FIG. 5), sees the CM broadcast (S502), and pushes, for example, an ‘interest button’ (not shown in the attached drawings) when the client is interested in the CM broadcast (YES in S503). At this time, the broadcast reception terminal device 10 displays the classification of merchandise as the CM information relating to the CM broadcast (S505).

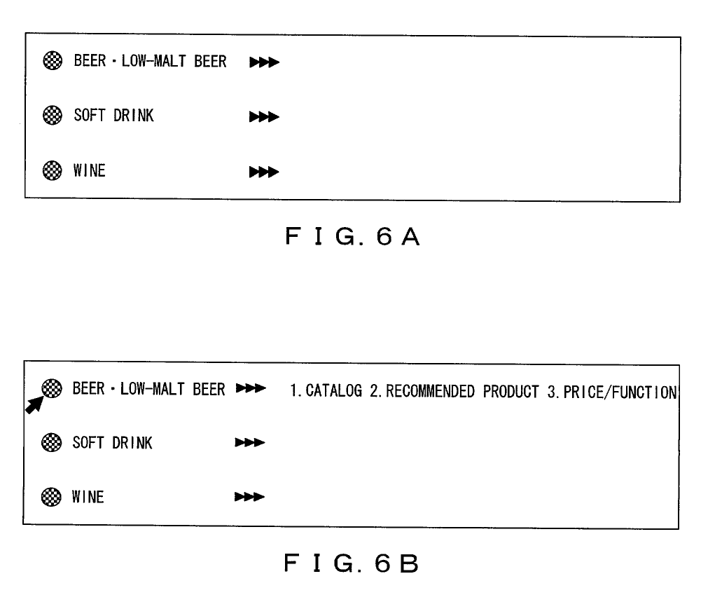

FIGS. 6A and 6B show examples of CM information displayed at this time. These examples show that the displayed CM information is the information about a drink. FIG. 6A shows the classification of the merchandise, that is, ‘beer and low-malt beer’, ‘soft drink’, and ‘wine’. The client selects a desired class on the display screen.

FIG. 6B shows the display screen when the client selects ‘beer and low-malt beer’. When the client selects ‘beer and low-malt beer’, ‘1: catalog’, ‘2: recommended merchandise’, are ‘3: by price/function’ are displayed on the display screen. These items are also displayed when the client selects ‘soft drink’ and ‘wine’.

Back in FIG. 5, the client selects a predetermined item from among ‘1: catalog’, ‘2: recommended merchandise’, and ‘3: by price/function’ shown in FIG. 6B (S506 and S507). An item is selected by, for example, the client operating a remote controller and inputting the number to be selected.

When the client selects ‘1: catalog’ (1 in S507), a merchandise catalog is displayed (S508) When the client selects predetermined merchandise from the merchandise catalog, the merchandise to be purchase by the client is determined (S511 in FIG. 5).

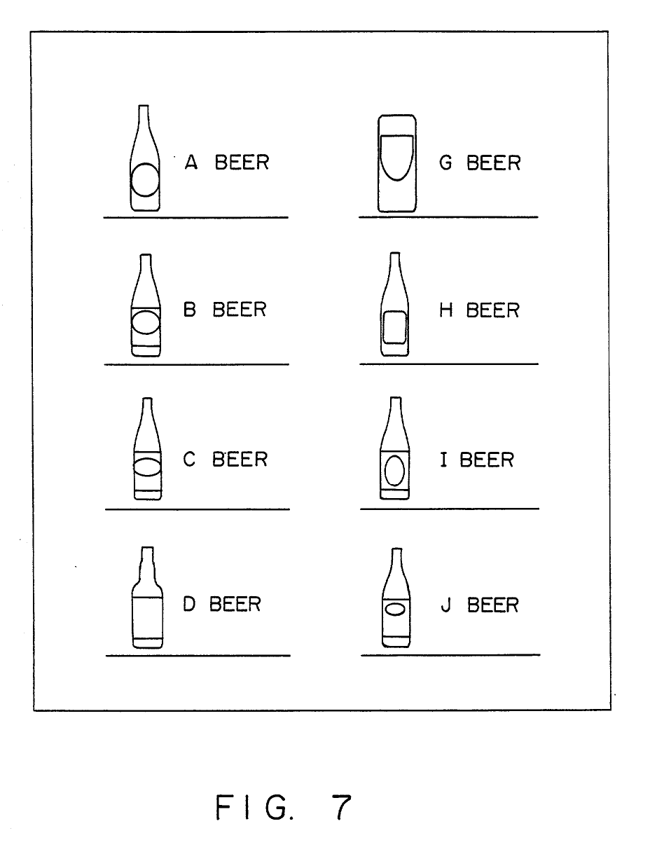

FIG. 7 shows an example of a merchandise catalog to be displayed. In FIG. 7, eight types of merchandise are displayed. The merchandise catalog shown in FIG. 7 is described by the MXL data as described above.

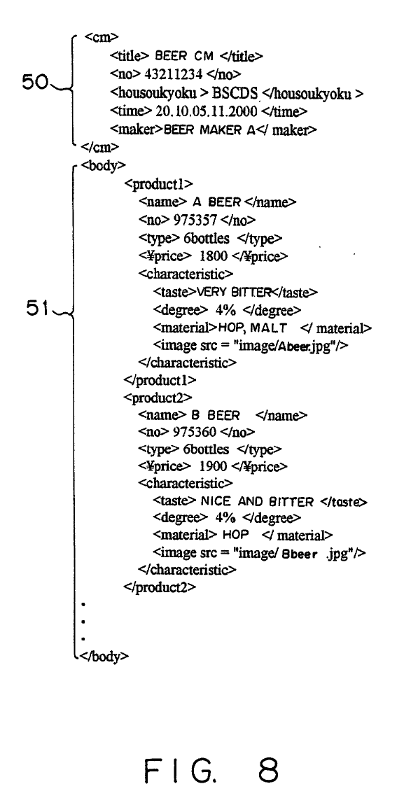

FIG. 8 shows an example of a merchandise catalog shown in FIG. 7 in the XML data format. As shown in FIG. 8, the merchandise catalog described in the XML data format comprises a description 50 about a CM broadcast and a description 51 about merchandise.

The description 50 relating to the CM broadcast is CM broadcast designation information designating a CM broadcast, and describes which CM broadcast the merchandise catalog relates to. The description 50 relating to the CM broadcast contains the title of a CM broadcast (title), the number of a CM broadcast (no), the broadcast station (housoukyoku), the broadcast time of a CM broadcast (time), the maker of merchandise in the CM broadcast (maker). In the case shown in FIG. 8, the merchandise catalog relates to the CM, broadcast from the BSCDS broadcast station on May 11, 2000 at 20:10, of beer of the beer maker A having the CM broadcast number 43211234.

The description 51 relating to merchandise describes for each piece of merchandise the name of merchandise (name), merchandise number (no), type (type), price (price), and characteristic (characteristic). As the characteristic (characteristic), the taste (taste), alcoholic degree (degree), material (material), and image (image) are described.

In FIG. 8, for example, the A beer has the merchandise number of 975357, and the price of the A beer is ¥1,800 for 6 bottles. The characteristic of the merchandise is: ‘bitter’ in taste, 4% in alcoholic degree, and hop and malt as material. The image file displayed on the display screen is ‘Abeer.jpg’.

Back in FIG. 5, when the client selects ‘2: recommended product’ (2 in S507), a recommended product customized for each client is displayed (S509).

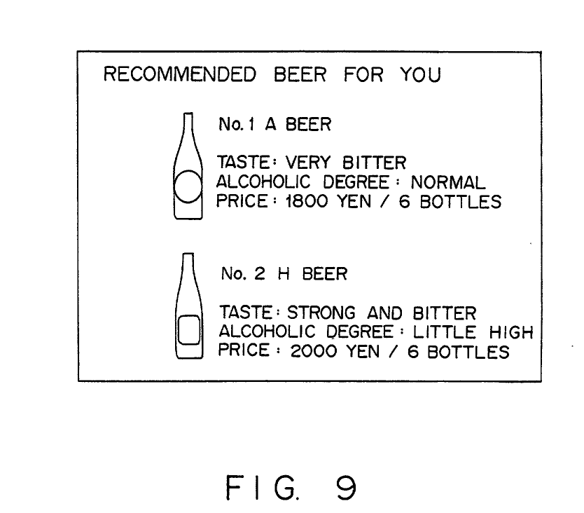

FIG. 9 shows the display screen of a recommended product. In FIG. 9, two pieces of merchandise are displayed as an example of recommended merchandise for a corresponding client together with the taste, the alcoholic degree, and the price. By selecting predetermined merchandise from the recommended products, the merchandise to be purchased by the client is selected (S511 shown in FIG. 5).

The information about the recommended products displayed at this time is displayed as follows. For example, when a client selects ‘2: recommended product’ shown in FIG. 6B, the information about the client stored in the broadcast reception terminal device 10 is transmitted to the computer 8 of the commerce out-sourcing center 1 through the Internet 7, the computer 8 retrieves the client information 17 in the DB 9 according to the information about the client, transmits the recommended merchandise information for the client from the taste data 26 of the corresponding client information 17 through the Internet 7, and the broadcast reception terminal device 10 displays the transmitted recommended merchandise information. If the client has been entered in the client information 17 in the DB 9, the commerce out sourcing center 1 periodically transmits the recommended merchandise information to the broadcast reception terminal device 10 based on the taste data 26 of the client information 17, and the broadcast reception terminal device 10 stores the recommended merchandise information in an added information display/control/storage unit 32 to display the stored recommended merchandise information when the client selects the ‘2: recommended product’ shown in FIG. 6B.

When the client selects the ‘3: by price/function’ (3 in S507 shown in FIG. 5), the classification of price/function is displayed based on the merchandise purchase guide book and merchandise purchase support page (S510).

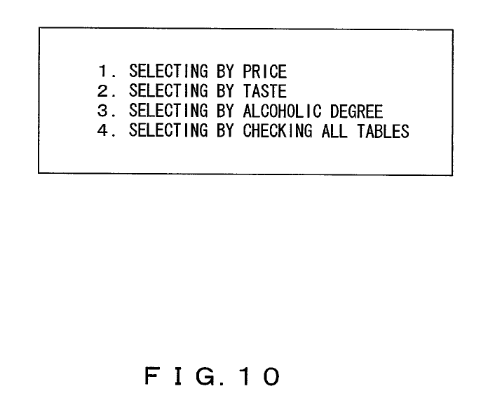

FIG. 10 shows the display screen of the displayed classification of price/function. In FIG. 10, as an example of the classification of price/function, four classification items, that is, ‘1. selecting by price’, ‘2. selecting by taste’, ‘3. selecting by alcoholic degree’, and ‘4: selecting by referring to all tables’, are displayed. The client can select merchandise by price/function on the display. In this example, processing when the client selects ‘1. selecting by price’ is explained.

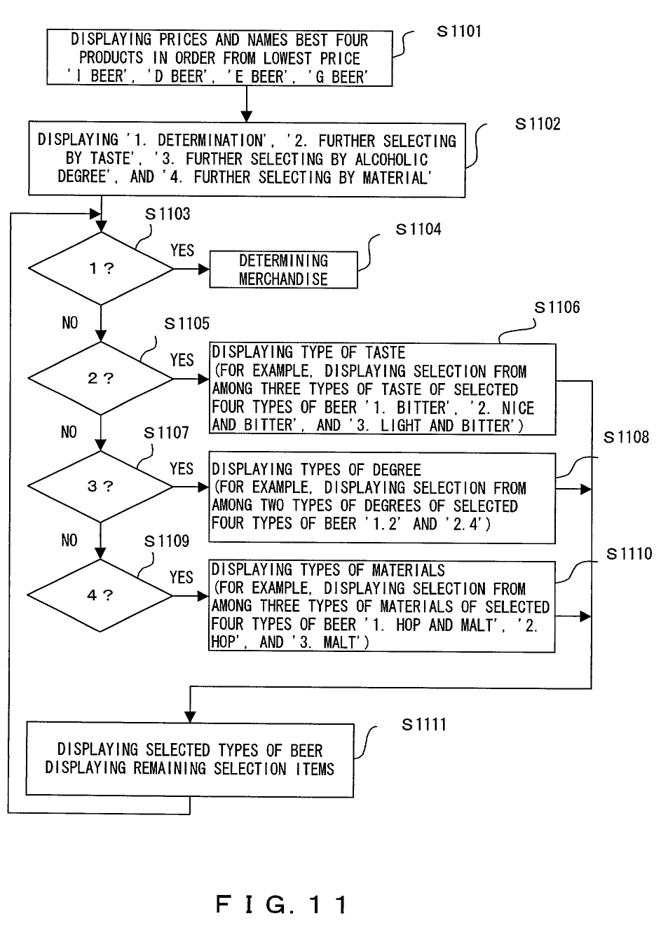

FIG. 11 is a flowchart of the process when a client selects ‘1. selecting by price’. As shown in FIG. 11, when ‘1. selecting by price’ is selected on the display screen of the classification of price/function shown in FIG. 10, four pieces of merchandise are displayed in order from the lowest price (S1101). In this example, ‘I Beer, D beer, E beer, and G beer’ is displayed in order from the lowest price. The displayed merchandise is not limited to four pieces, but can be any number of pieces.

On the display screen on which four pieces of merchandise are displayed, the selection items of ‘1. determination’, ‘2. further selecting by taste’, ‘3. further selecting by alcoholic degree’, and ‘4. further selecting by material’ are displayed together (S1102). When a client selects a predetermined selection item from the selection items, a process is performed based on the selection items.

That is, when the client selects ‘1. determination’ (YES in S1103), the merchandise being displayed at this time is selected as the merchandise to be purchased (S1104). When there are plural pieces of displayed merchandise, then the client can be allowed to select merchandise to be purchased from among the plural pieces of the merchandise.

When the client selects ‘2. further selecting by taste’ without selecting ‘1. determination’ (YES in S1105), the selection items indicating the types of taste of the merchandise being displayed, for example, ‘1. bitter’, ‘2. nice and bitter’, and ‘3. light and bitter’ are displayed (S1106). When the client selects any of the selection items indicating the types of taste, the merchandise of the type of taste corresponding to the selection item is extracted from the merchandise (for example, four pieces of merchandise being displayed in order from the lowest price) being displayed, and only the extracted merchandise is displayed. The remaining selection items are displayed (S1111), and then control is returned to the process in S1103. A remaining selection item refers to any of the selection items displayed in the process in S1102. For example, if ‘2. further selecting by taste’ has been selected, the remaining selection items are ‘1. determination’, ‘3. further selecting by alcoholic degree’, and ‘4. further selecting by material’. Furthermore, if ‘2. further selecting by taste’ and ‘3. further selecting by alcoholic degree’ have been selected, the remaining selection items are ‘1. determination’ and ‘4. further selecting by material’.

If the client has selected ‘3. further selecting by alcoholic degree’ without selecting ‘1. determination’ (YES in S1107), then the selection items indicating the types of alcoholic degrees of the merchandise being displayed, for example, ‘1. alcoholic degree 2’ and ‘2. alcoholic degree 4’ are displayed (S1108). If the client has selected any of the selection items indicating the types of alcoholic degree, then the merchandise of the type of the alcoholic degree corresponding to the selection item is extracted from the merchandise (for example, four pieces of merchandise displayed in order from the lowest price) being displayed, only the extracted merchandise is displayed, the remaining selection item not yet selected is displayed (S1111), and control is returned to the process in S1103.

If the client has selected ‘4. further selecting by material’ without selecting ‘1. determination’ (YES in S1109), then the selection item indicating the type of material of the merchandise being displayed, for example, ‘1. hop and malt’, ‘2. hop’, and ‘3. malt’ are displayed (S1110). If the client has selected any of the selection items indicating the types of material, then the merchandise of the type of the material corresponding to the selection item is extracted from the merchandise (for example, four pieces of merchandise displayed in order from the lowest price) being displayed, and only the extracted merchandise is displayed. Then, the remaining selection items not yet selected are displayed, and control is returned to the process in S1103.

Thus, ‘1. selecting by price’ is selected on the display screen of the classification by price/function shown in FIG. 10, the merchandise is selected according to the flowchart shown in FIG. 11, and the merchandise to be purchased is determined (S1104 shown in FIG. 11, and S511 shown in FIG. 5). The process performed when the client selects ‘2. further selecting by taste’ or ‘3. further selecting by alcoholic degree’ on the display screen of the classification by price/function shown in FIG. 10 is performed as according to the flowchart shown in FIG. 11.

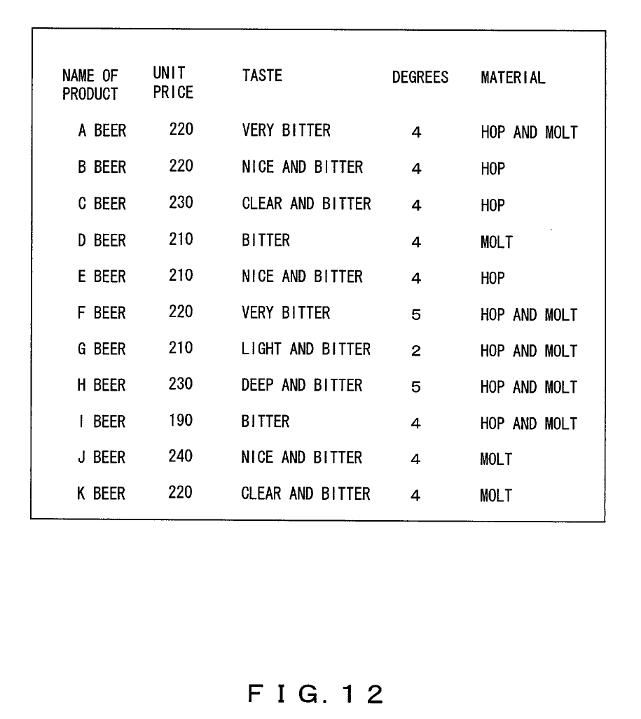

FIG. 12 shows the screen displayed when ‘4. selecting by referring to all lists’ is selected on the display screen of the classification by price/function shown in FIG. 10. As shown in FIG. 10, the name of merchandise, price, taste, alcoholic degree, and material are displayed for every merchandise. The client can determine the merchandise to be purchased by selecting predetermined merchandise on the display screen (S511 shown in FIG. 5).

Back in FIG. 4, when the merchandise is selected as described above (S412), the client either orders the selected merchandise through Internet 7 or purchases it at the retail shop 4 (S414). The payment for the merchandise is made using a credit card, digital money, etc.

When the selected merchandise is ordered through Internet 7 (YES in S414), the client can order the merchandise through the broadcast reception terminal device 10. In this case, at least the order information containing the merchandise information including the CM broadcast designation information about the merchandise selected by the client and the information about the client stored in the broadcast reception terminal device 10 is transmitted from the broadcast reception terminal device 10 to the computer 8 of the commerce out-sourcing center 1 through Internet 7. The information about the client can be directly input from the broadcast reception terminal device 10 when the client orders the merchandise through Internet 7.

Upon receipt of the order information (S415), the computer 8 updates the merchandise information 15, the client information 17, etc. in the DB 9 according to the order information (S416), and assigns a point to the client who placed the order. Thus, the commerce information such as the information about the merchandise the client has purchased, the information about the client, and the CM broadcast designation information indicating through which CM broadcast the client has purchased the merchandise, etc entered in the DB 9. The CM broadcast designation information is used later in measuring (computing) the advertising effect of the CM broadcast. When the information about a client has not been entered in the client information 17, it is added to the client information 17. Then, the commerce out-sourcing center 1 notifies the merchandise producer 5 of the order of the merchandise.

Upon receipt of the order of the merchandise, the merchandise producer 5 delivers the merchandise to the client (client home 3) who placed the order (S417). Otherwise, the merchandise can be temporarily transmitted to the retail shop 4, and the client can receive the merchandise.

After receiving the merchandise, the client answers the questionnaire about the merchandise (S418). The questionnaire is to check, for example, how easily the user can use the merchandise, the requests, the claims, the suggestions for improvements, etc. about the merchandise. The answer to the questionnaire can be made using a post card enclosed with the merchandise, or by accessing the URL for the questionnaire about the merchandise through Internet 7 to answer the questionnaire.

The result of the answer to the questionnaire is transmitted to the commerce out-sourcing center 1 to analyze data (S419). Based on the data analysis result, the merchandise data 18 of the merchandise information 15 and the taste data 26 of the client information 17, etc. in the DB 9 are further updated.

At this time, a service point can be assigned to a client who answers the questionnaire to improve the questionnaire answer rate from clients. The result of the data analysis is transmitted to the merchandise producer 5 for use in improving the merchandise and developing new merchandise (S420).

On the other hand, when the selected merchandise is purchased at a retail shop 4 (NO in S414), the client transmits and receives data between the broadcast reception terminal device 10 and the portable terminal device 11, and transmits the selected merchandise information from the broadcast reception terminal device 10 to the portable terminal device 11 (S421). The merchandise information transmitted to the portable terminal device 11 contains CM broadcast designation information, and only the necessary items in the above mentioned merchandise catalog and merchandise guide book, etc. described in the above mentioned XML data format are transmitted as is in the XML data format.

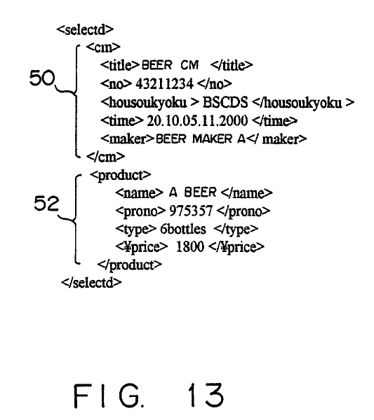

FIG. 13 shows an example of merchandise information transmitted to the portable terminal device 11. It practically shows the merchandise information when the merchandise selected by the client is ‘A beer’. As necessary items, the merchandise information contains the description 50 relating to the CM broadcast shown in FIG. 8, that is, the CM broadcast designation information such as the title of a CM broadcast (title), the number of CM broadcast (no), a broadcasting station (housoukyoku), the broadcast time of a CM broadcast (time), the maker of merchandise in the CM broadcast (maker), etc. and the description 52 indicating the merchandise selected by the client such as the name of merchandise (name), the number of merchandise (no), the type (type), the price (price), etc.

Back in FIG. 4, when the information about the selected merchandise is transmitted to the portable terminal device 11, the client goes to the retail shop 4 with the portable terminal device 11, and purchases merchandise at the retail shop 4 (S422). At the retail shop 4, the merchandise delivered from the merchandise producer 5, that is, the merchandise selected by the client, is displayed (S423). When the client purchases the merchandise, transmission and reception of data are performed between the portable terminal device 11 and the terminal device 12 of the retail shop 4, and the information about the selected merchandise and the information about the client is transmitted from the portable terminal device 11 to the terminal device 12 (S424). The information about the client can be input directly by the client to the terminal device 12. Furthermore, when the client purchases plural pieces of merchandise, he or she can input the number of pieces of merchandise to be purchased.

The merchandise information, client information, and merchandise purchase number information are transmitted to the computer 8 of the commerce out-sourcing center 1 from the terminal device 12 as purchase information. The purchase information is described, for example, in the XML data format.

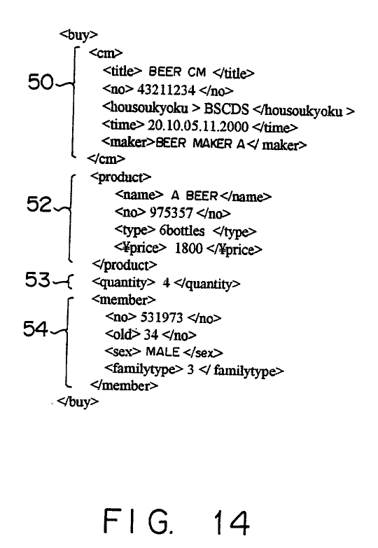

FIG. 14 shows an example of the transmitted purchase information. As shown in FIG. 14, the purchase information contains the description 50 of the CM broadcast, that is, the CM broadcast designation information shown in FIGS. 8 and 13 as merchandise information, the description 52 indicating the merchandise selected by the client shown in FIGS. 13, the description 53 about the purchase number information about the merchandise, and the description 54 about the information about the client. The purchase information shown in FIG. 14 indicates that the client has purchased four bottles of merchandise of ‘A beer’ according to the description 53 of the purchase number information about the merchandise, and also indicates the family of the client who is 34-year-old male client having the client identification number 531973 and living with three family members according to the description 54 of the information about the client.

Back in FIG. 4, upon receipt of the above mentioned purchase information, the computer 8 of the commerce out-sourcing center 1 updates the merchandise information 15, the client information 17, etc. in the DB 9 according to the purchase information (S416), and assigns service points to the client who has purchased the merchandise. Thus, the commerce information such as the information about the merchandise purchased by the client, the information about the client, the CM broadcast designation information indicating through which CM broadcast the client has purchased the merchandise, etc. entered in the DB 9. The CM broadcast designation information is used in measuring (computing) the advertising effect of the CM broadcast.

Afterwards, the flowchart after the purchase of the merchandise by the client is the same as steps S418 through S420 described above. That is, the client answers the questionnaire about the merchandise (S418). The result of the answer is analyzed in the commerce out-sourcing center 1 (S419). Based on the analysis result, the merchandise information 15, the client information 17, etc. in the DB 9 are updated. Then, a service point is assigned to the client who answers the questionnaire, and the result of the data analysis is transmitted to the merchandise producer 5, and is used in improving the merchandise and developing new merchandise (S420).

According to the present embodiment, the CM information is broadcast through a digital broadcasting. However, the CM information can also be broadcast using an Internet broadcasting and a mobile broadcasting. In this case, a broadcast can be realized with the locality and the attribute of a client taken into account. Furthermore, the commerce out-sourcing center 1 itself can open a Web site through Internet to realize an Internet broadcasting using a home page, etc.

As described above, according to the present invention, the commerce out-sourcing center 1 can collectively manage various types of commerce information such as the CM broadcast designation information, the information about merchandise and services, the information about the client, etc. transmitted from the merchandise producer 5, the service provider 6, the retail shop 4, the client home 3 (client), etc., and can associate the attribute data of a client (person) with the information about the merchandise or service purchased by the client.

Thus, it is possible to analyze the purchased data of each client from the information about the client transmitted each time the client purchases merchandise or a service. Furthermore, it is possible to collect the questionnaire from the client, and, for example, a life plan of the client can be generated based on the analysis result. In addition, based on the life plan, a suggestion about merchandise or a service can be presented to the merchandise producer 5 and the service provider 6.

Furthermore, since the commerce out-sourcing center 1 can collectively manage the commerce information which has been independently distributed for each company such as the merchandise producer 5, the service provider 6, etc. or for each medium such as a digital broadcasting, Internet, etc., it is also possible to associate and process the commerce information which has been distributed for each company such as the merchandise producer 5, the service provider 6, etc., thereby realizing the advertisement and purchase with a digital broadcasting and Internet, etc. cooperating with each other.

In addition, the commerce out-sourcing center 1 can obtain the tendency of a client for taste, etc. in detail according to the associated commerce information. If the merchandise producer 5 and the service provider 6 obtain the taste tendency, etc., a more effective advertising can be realized, merchandises and services can be improved, and new merchandise and services can be developed.

Furthermore, the commerce out-sourcing center 1 can collectively manage enormous volume of commerce information in a larger range than the commerce information which can be independently managed by the merchandise producer 5 and the service provider 6.

By the commerce out-sourcing center 1 collectively managing the commerce information, it is not necessary for the merchandise producer 5 and the service provider 6 to own the computer, the database, etc. for management of the commerce information, thereby requiring no staff or cost of managing them.

Furthermore, small merchandise producers 5 and service provider 6 which have not been able to have their own expensive computers or databases for management of commerce information can obtain information according to an large volume of commerce information in a wide range.

In addition, although it has been necessary for the merchandise producer 5 or the service provider 6 to make a contract with a client in advance to collect commerce information, for example, the commerce information about the merchandise on sale through the distribution path of a retail shop 4, etc., relating to the merchandise or the services on sale through a distribution path, the merchandise producer 5 and the service provider 6 can be free of the operations relating to making the contract by the commerce out-sourcing center 1 collectively performing the operations. When the commerce information is used after the contract with a client, the client is assigned a service point for incentive, thereby promoting the contract.

Additionally, the commerce out-sourcing center 1 collectively manages the client information to prevent the client information from being disclosed. That is, the information transmitted from the commerce out-sourcing center 1 to the merchandise producer 5 or service provider 6 is an analysis result, etc. according to the commerce information without transmission of the client information. Although the client information should be transmitted, it can be transmitted without a source or destination name, thereby suppressing the possibility of disclosing the client information.

Examples of the hardware configurations of the broadcast reception terminal device 10 and the portable terminal device 11 are described below.

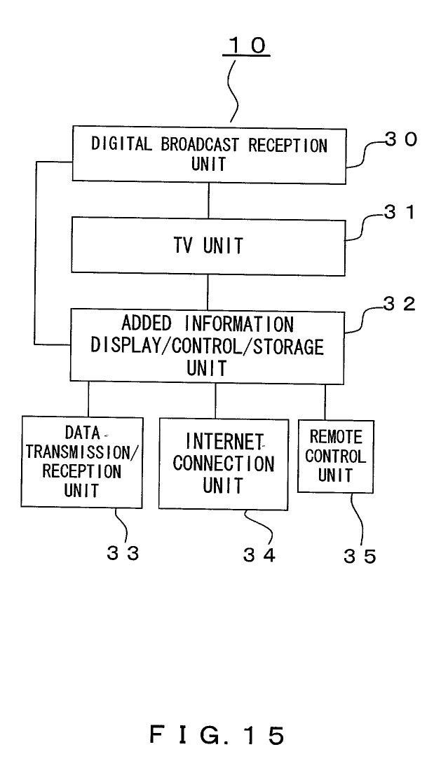

FIG. 15 shows the hardware configuration of the broadcast reception terminal device 10. As shown in FIG. 15, the broadcast reception terminal device 10 comprises: a digital broadcast reception unit 30 for receiving a digital broadcasting from the broadcasting station 2; a TV unit 31 having a normal TV function such as a display/speaker, etc.; an added information display/control/storage unit 32 for controlling the display and the storage of added information (CM information, etc.) to a main program and a CM broadcast; a data transmission/reception unit 33 for transmitting and receiving data with the portable terminal device 11; a Internet connection unit 34 for connection to Internet 7; a remote control unit 35 for receiving a remote control output signal output by a client operating a remote controller (not shown in the attached drawings), etc.

With the above mentioned configuration, the broadcast reception terminal device 10 allows the TV unit 31 to broadcast the main program and the CM broadcast from the broadcasting station 2, and stores the added information relating to the main program and the CM broadcast in the added information display/control/storage unit 32. The added information display/control/storage unit 32 also stores the added information, client information, etc. periodically transmitted from the commerce out-sourcing center 1 through Internet 7. For example, when the client operates a remote controller to see the added information and a display indication signal for the added information is output by the remote controller, the remote control unit 35 receives the signal, and outputs it to the added information display/control/storage unit 32. The added information display/control/storage unit 32 receives the signal, and display-controls the stored added information on the display of the TV unit 31.

In addition, the added information and the client information stored in the added information display/control/storage unit 32 is transmitted as necessary to the portable terminal device 11 through the data transmission/reception unit 33.

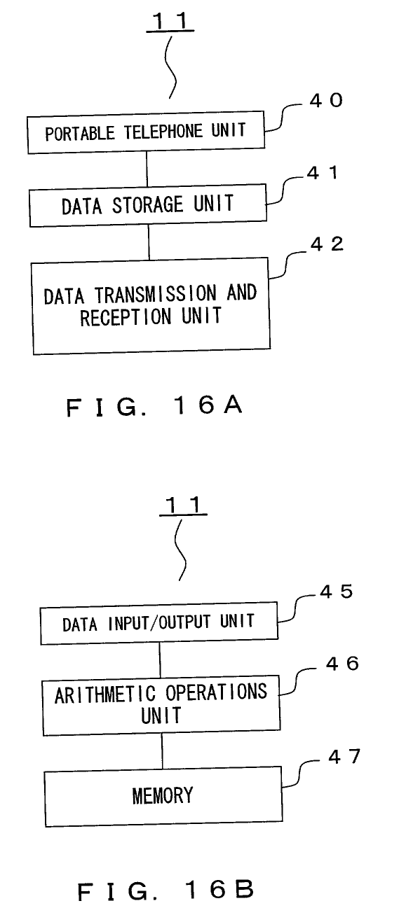

FIGS. 16A and 16B show the hardware configuration of the portable terminal device 11. In this example, FIG. 16A shows the portable terminal device 11 as a portable telephone, and FIG. 16B shows it as a smart card.

As shown in FIG. 16A, when the portable terminal device 11 is a portable telephone, the portable terminal device 11 comprises: a portable telephone unit 40 having the function of a normal portable telephone; a data storage unit 41 for storing data; a data transmission and reception unit 42 for transmitting and receiving data to and from the broadcast reception terminal device 10 and the terminal device 12, etc. According to the present embodiment, the added information output from the broadcast reception terminal device 10 is stored in the data storage unit 41 through the data transmission and reception unit 42, and the added information stored in the data storage unit 41 and the client information stored in advance are output to the terminal device 12 through the data transmission and reception unit 42.

Furthermore, as shown in FIG. 16B, when the portable terminal device 11 is a smart card, the portable terminal device 11 comprises: a data input/output unit 45 for inputting and outputting data; an arithmetic operations unit 46 for encrypting the input data and decrypting the encrypted data; memory 47 storing the encrypted data, etc. The memory 47 is, for example, nonvolatile memory, etc. According to the present embodiment, the added information output from the broadcast reception terminal device 10 is received by the data input/output unit 45, encrypted by the arithmetic operations unit 46, and stored in the memory 47. Furthermore, the encrypted and stored added information and client information are decrypted, and the decrypted information is output from the data input/output unit 45 to the terminal device 12.

Described below is the second embodiment of the present invention.

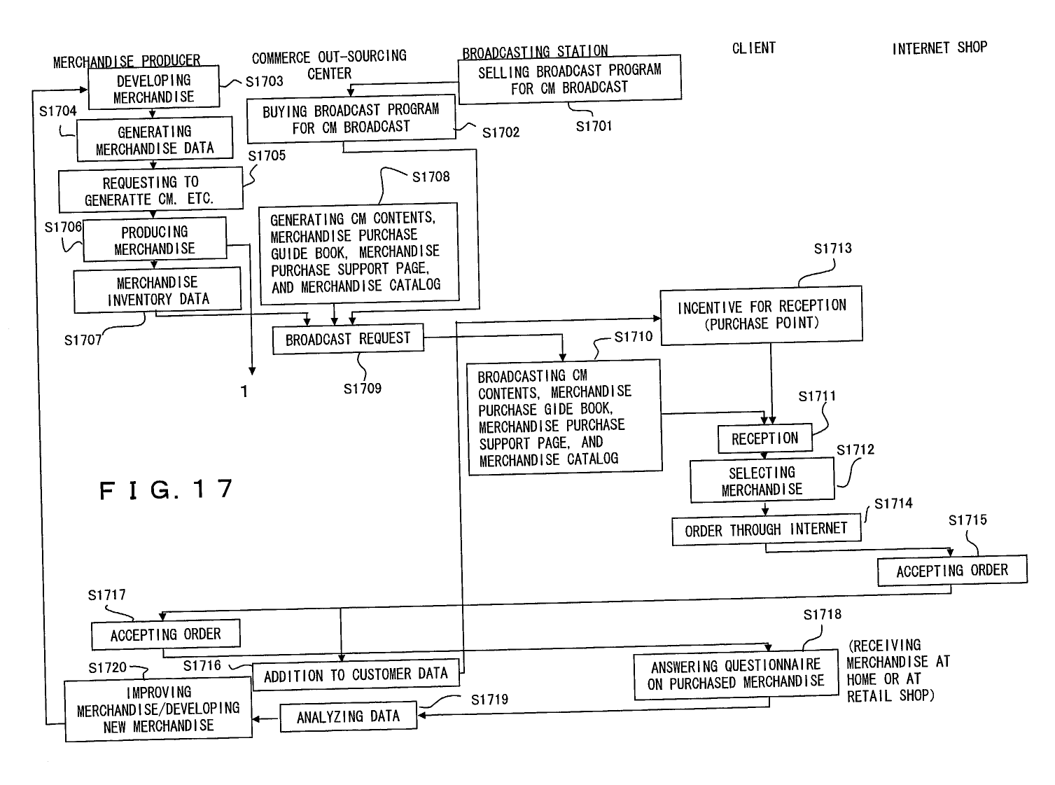

FIG. 17 is a flowchart according to the second embodiment of the present invention. The flowchart shown in FIG. 17 corresponds to the flowchart shown in FIG. 4 according to the first embodiment. However, according to the second embodiment, when selected merchandise by the client is ordered through Internet, it is not ordered in the commerce out-sourcing center 1, but in an Internet. An Internet shop refers to a Web site for selling merchandise and a service through Internet 7. According to the present embodiment, a plurality of Internet shops have made contracts with the commerce out-sourcing center 1 in advance. In FIG. 17, the flow of the commerce information relating to merchandise is mainly described, but the present invention is not limited to this application, but a flow of the commerce information relating to services can be similarly processed.

In FIG. 17, the processes in S1701 through S1713 are the same as the processes in S401 through S413 shown in FIG. 4. Therefore, the detailed explanation of the processes is omitted here.

After the processes, the client selects the merchandise to be purchased through the broadcast reception terminal device 10 (S1712), and orders it through Internet 7 (S1714). Then, the merchandise information (containing the CM broadcast designation information) about the selected merchandise and the order information containing the information about the client, etc. are transmitted from the broadcast reception terminal device 10 to an Internet shop dealing in the selected merchandise through Internet 7.

Upon receipt of the order information (S1715), the Internet shop transmits the order information to the commerce out-sourcing center 1.

The commerce out-sourcing center 1 updates the merchandise information 15, the client information 17, etc. in the DB 9 according to the order information received from the Internet shop (S1716), and assigns a service point to the client. If the information about the client who ordered the merchandise has not been entered in the client information 17, it is added to the client information 17. Then, the commerce out-sourcing center 1 notifies the merchandise producer 5 of the receipt of the order of the merchandise.

Upon receipt of the order of the merchandise, the merchandise producer 5 delivers the merchandise to the client (client home 3) who ordered the merchandise (S1717). Otherwise, the merchandise can be temporarily delivers to the retail shop 4 at which the client can receive the merchandise.

Since the subsequent processes in S1718 through S1720 are the same as the processes in S418 through S410 shown in FIG. 4, the explanation of the processes are omitted here.

According to the present embodiment, if the merchandise producer 5 and the service provider 6 open Web sites on which a client can purchase merchandise or a service, the Web sites of the merchandise producer 5 and the service provider 6 can be used instead of Internet shops.

As described above, by using Internet shops to which an order of merchandise or a service can be issued, the commerce information distribution system can contain Internet shops, thereby realizing a wider range of distribution of commerce information.

Described below is the third embodiment of the present invention.

In the first and second embodiments, the CM broadcast and the CM information relating to the CM broadcast which the broadcasting station 2 is requested to process are not changed for their broadcasting time and contents of the broadcast program. However, according to the third embodiment, the broadcasting time and contents of the broadcast program can be changed as necessary after starting the broadcast.

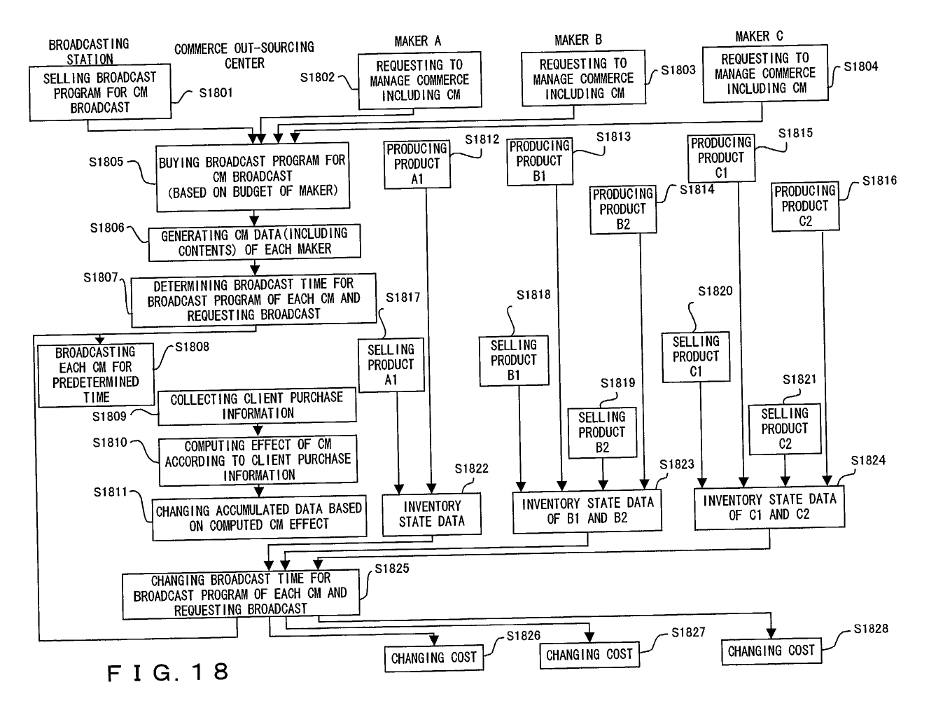

FIG. 18 is a flowchart according to the third embodiment. FIG. 18 shows an example of changing the broadcasting time and contents of the broadcast program based on the inventory state of the product (merchandise). In this example, a change is made based on the inventory state of the product of the merchandise producer 5, but the similar process can be performed when a change is made based on the service providing state, etc. of a service provider.

As shown in FIG. 18, the broadcasting station 2 sells the broadcast program of a CM broadcast (S1801). On the other hand, the merchandise producers 5, that is, a maker A, a maker B, and a maker C, request the commerce out-sourcing center 1 to prepare a CM broadcast and CM information relating to the CM broadcast and to manage commerce information (S1802 through S1804). In this example, three makers are described as merchandise producers, but it is obvious that the number of producers is not limited to three.

The commerce out-sourcing center 1 receives requests from the makers A, B, and C, considers the budget presented by each makers, and buys the broadcast program from the broadcasting station 2 (S1805). Then, it prepares a CM broadcast and the CM information relating to the CM broadcast for each maker (S1806), and determines the broadcast program of the CM broadcast for each maker. The broadcast program is determined according to the broadcast program purchased in S1804 and the commerce information such as the CM broadcast designation information, etc. stored in the DB 9, and the broadcast program most effective for the merchandise is determined. The commerce outsourcing center 1 requests the broadcasting station 2 to broadcast the CM broadcast and the CM information relating to the CM broadcast for each maker in a broadcast program determined for each maker (S1807).

The broadcasting station 2 broadcasts the CM broadcast and the CM information relating to the CM broadcast for each maker for a predetermined period (S1808).

After the broadcast starts, an increasing number of clients purchase the merchandise as a result of the CM broadcast. Therefore, the purchase information about the clients, that is, as in the above mentioned first and second embodiments, the merchandise information (containing the CM broadcast designation information) about the merchandise purchased by the client, the client information, the information about the number of pieces of purchase merchandise, etc. are transmitted to the computer 8, and the merchandise information 15 and the client information 17 in the DB 9 are updated (S1809). At this time, the advertising effect, etc. of the CM broadcast is computed according to the CM broadcast designation information contained in the merchandise information (S1810). Based on the computed advertising effect, the relevant commerce information entered in the DB 9 is further updated (S1811).

On the other hand, each maker produces (S1812 through S1816) and sells (S1817 through S1821) merchandise currently broadcast, and computes the inventory state data based on the production state, the sales state, etc. of each product (S1822 through S1824). The computed inventory state data of each maker is periodically transmitted to the commerce out-sourcing center 1.

The commerce out-sourcing center 1 changes the broadcasting time and contents of the broadcast program of the currently broadcast CM broadcast and the CM information relating to the CM broadcast based on the inventory state data received from each maker.

A change of the broadcasting time and contents of a broadcast program is performed in order to make the shortage of stock ease. For example, when the stock of the product C1 of the maker C is small, the broadcasting time can be reduced for the CM broadcast for a product C1 or the broadcasting time can be changed for a less advertising effect, based on the inventory state data of each maker. Otherwise, the broadcasting contents can be changed into those of, for example, another product C2, or into the contents for improving the impression of the maker C. On the other hand, when the stock of the product C1 is large, the broadcasting time can be increased for the CM broadcast for the product C1 to promote the clients to buy more products C1.

The broadcasting time and contents of the broadcast program can also be changed based on the commerce information stored in the DB 9, for example, the stored sales information in addition to the sales state data. In this case, since the sales of the products can be predicted based on the previous sales records, a change can be made based on the prediction. Otherwise, the broadcasting time and contents of the broadcast program can be changed according to the CM broadcast designation information, and the broadcasting time of the broadcast program can be changed for a time period recommended for a target age group according to the age group of the clients who purchased the products.

Then, the broadcasting time and contents of the changed broadcast program are given to the broadcasting station 2 to request it to broadcast the information again (S1825).

Upon receipt of the broadcast request, the broadcasting station 2 changes the currently broadcast CM broadcast and the CM information relating to the CM broadcast at the request to broadcast a changed broadcast program (S1808).

Each maker also changes the CM broadcast rate to be paid when the broadcasting time and contents of the broadcast program are changed (S1826 through S1828).

According to the present embodiment, The broadcasting time and contents of the broadcast program of the CM broadcast and the CM information relating to the CM broadcast can be changed based on the inventory state data of each maker, thereby performing an effective and flexible advertising process.

Described below is the fourth embodiment of the present invention.

In the above mentioned first through third embodiments, when a client orders merchandise through Internet 7, the ordered merchandise is delivered from the merchandise producer 5 directly to the client (client home 3), or is temporarily delivered to the retail shop 4 at which the client can receive the merchandise. Normally, a staff of the retail shop 4 who receives and provides the merchandise for the client only receives and provides it for the client. That is, the staff does not have sufficient knowledge about the merchandise. In addition, the number of the branch offices of the merchandise producer 5 is not so large, and is limited.

Therefore, for example, the client feels inconvenience when the client requests to have the explanation of the purchased merchandise, requests to have the purchased merchandise set, requests to have the aftercare of the purchase merchandise, etc.

The fourth embodiment has been developed to satisfy all these requests of the client.

For example, in the second embodiment, the request of the client can be satisfied. In this example, the merchandise has been purchase by the client, but a service purchased by the client can also be similarly processed.

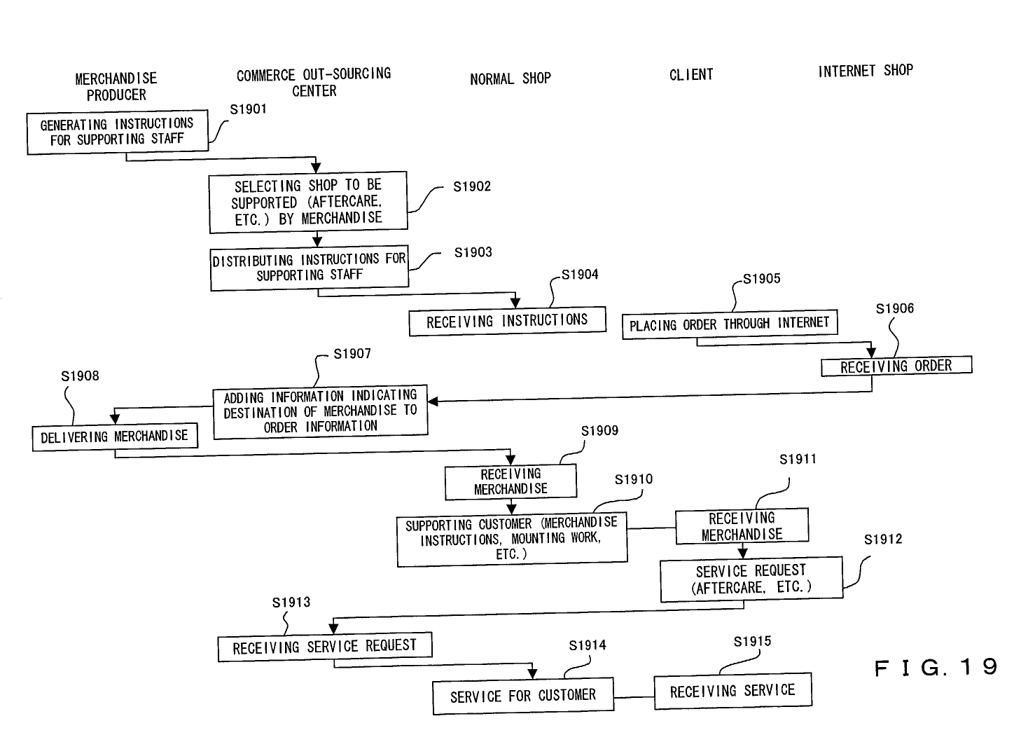

FIG. 19 is a flowchart according to the fourth embodiment. As shown in FIG. 19, the merchandise producer 5 prepares merchandise instructions for a support staff (S1901), and provides it for the commerce out-sourcing center 1.

Upon receipt of the merchandise instructions, the commerce out-sourcing center 1 selects a supportable shop (normal shop) from the DB 9 (S1902). A supportable shop refers to a shop with which the commerce out-sourcing center 1 has made a contract. These shops are entered in the DB 9 as shop information by merchandise. When supportable shops are selected, the merchandise instructions are distributed to the shops (S1903).

The shop to which the merchandise instructions are distributed receives them (S1904), and accumulates the knowledge about the merchandise according to the merchandise instructions. That is, the shop accumulates the knowledge about the merchandise such that it can satisfy a service or support request from a client about the merchandise.

When the client orders the merchandise at the Internet shop (S1905, S1906), the Internet shop temporarily transmits the order information of the client to the commerce out-sourcing center 1.

The commerce out-sourcing center 1 selects the shop, etc. which can satisfy the service request or the support request of the client and is closest to the client home 3 from the shop information by merchandise in the DB 9 according to the order information. Then, it transmits the destination information indicating the selected shop in addition to the order information to the merchandise producer 5 (S1907).

The merchandise producer 5 receives the order information, and delivers the merchandise to a predetermined shop according to the information indicating the destination (S1908).

The shop receives the delivered merchandise (S1909), and support the client by explaining the merchandise, mounting the merchandise, etc. by a supporting staff of the shop at the client home 3 according to the distributed merchandise instructions (S1910).

The client receives the above mentioned support, and accepts the merchandise (S1911). When a service request such as aftercare, etc. for the merchandise is to be issued, the client issues the service request to the commerce out-sourcing center 1 (S1912).

The commerce out-sourcing center 1 receives the service request (S1913), and transmits the service request of the client to the above mentioned shop.

Upon receipt of the request, the shop provides a requested service to the client (S1914), and the client receives the requested service (S1915).

As described above, according to the present embodiment, when the merchandise is purchased the client can receive sufficient explanation of the merchandise and can have a supporting service such as properly setting the merchandise. After the purchase of the merchandise, the aftercare of the merchandise can be provided.

Described below is the fifth embodiment of the present invention.

According to the present embodiment, an authenticating process is performed when a client purchases merchandise through Internet 7, when he or she purchases merchandise at the retail shop 4, when the client receives the merchandise at the retail shop 4, etc. to protect against pretense and improve the authentication rate of the commerce information. The authentication according to the present embodiment is not performed in an Internet shop or the retail shop 4, etc., but is performed by other organizations for authentication.

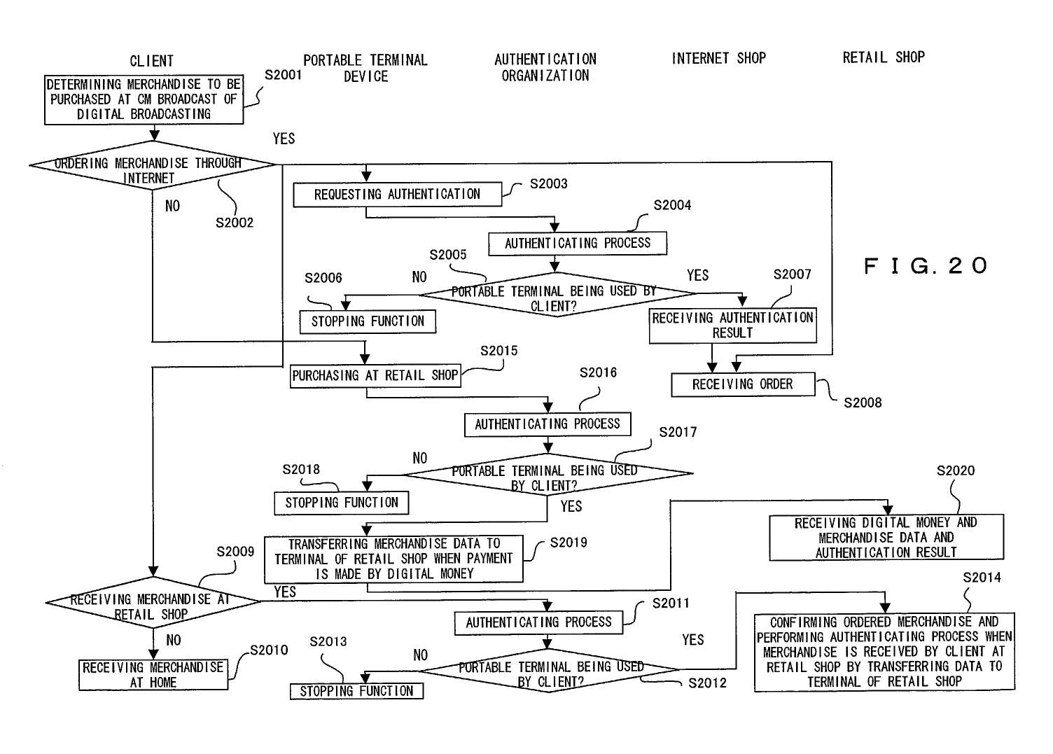

FIG. 20 is a flowchart according to the fifth embodiment of the present invention. In FIG. 20, since the authenticating process is mainly described, and other processes are the same as those according to the first through fourth embodiment, the detailed explanation is omitted here.

As shown in FIG. 20, the broadcast reception terminal device 10 of the client receives a digital broadcasting from the broadcasting station 2, selects merchandise to be purchased from the CM broadcast, and inputs the merchandise information of the selected merchandise into the portable terminal device 11 (S2001). The merchandise information contains the URL information, etc. about the Internet shop at which the merchandise is ordered.

The portable terminal device 11 has the function of authenticating a client, and requests an authentication organization for authenticating a client to authenticate the client when the authentication is required. Furthermore, the portable terminal device 11 also has the function of connecting to Internet 7, and a single portable terminal device 11 can connect to Internet 7.

Then, the client orders and purchases selected merchandise through Internet 7 or at the normal retail shop 4 (S2002).

When the selected merchandise is purchased through Internet (YES in S2002), the client is connected to Internet through the portable terminal device 11, and orders the merchandise by, for example, pressing the order button (not shown in the attached drawings) of the portable terminal device 11. When the order button is pressed, the authentication organization is requested to authenticate the client (S2003). When the request is issued, the URL information about the Internet shop is transmitted together to the authentication organization. At this time, the portable terminal device 11 transmits the merchandise information and the information about the client to the Internet shop indicated by the URL information contained in the merchandise information.

The authentication organization requested to authenticate the client performs the authenticating process (S2004), and determines whether or not the user of the portable terminal device 11 is the owner of the portable terminal device 11 (S2005).

The authenticating process performed by the authentication organization is described later.

When the authentication organization determines that a third party is using the portable terminal device 11 (NO in S2005), it transmits an check result that the third party, not the client, is using the device to the Internet shop indicated by the URL information. At this time, the authentication organization stops the function of the portable terminal device 11 (S2006).

When the Internet shop receives a check result that the third party is using the device from the authentication organization, it determines that the order from the third party is illegal, and rejects the order.

On the other hand, when the authentication organization determines that the correct client is using the portable terminal device 11 (YES in S2005), it transmits an authentication result that the correct client is using the device to the Internet shop indicated by the URL information.

Upon receipt of the authentication result that the correct client is using the device, and the previously transmitted merchandise information and client information (S2007), the Internet shop formally accept the order of the merchandise (S2008). When the order is accepted, the client can specify the number of pieces of merchandise, the shop at which the client can receive the merchandise (retail shop 4), etc.

Thus, the pretense can be avoided, that is, an illegal user pretending to be a client can be detected when he or she orders merchandise through Internet 7.

When a client orders merchandise through Internet 7, the information about a specified retail shop 4 and the information about the ordered merchandise, etc. can be transmitted from an Internet shop to the portable terminal device 11, and the portable terminal device 11 stores the information.

When the client does not receive the merchandise ordered through Internet at the retail shop 4 (NO in S2009), the client receives the merchandise at home (S2010).

When the ordered merchandise is received at the retail shop 4 (YES in S2009), the client receives a notification that the merchandise has been delivered to the retail shop 4, and then visits the retail shop 4 with the portable terminal device 11. The notification of the delivery of the merchandise is transmitted from the commerce outsourcing center 1 . The commerce out-sourcing center 1 manages the order state of merchandise, and notifies the portable terminal device 11 of the client that the ordered merchandise has arrived at the retail shop 4.

When the client visits the retail shop 4 with the portable terminal device 11, it transmits and receives data between the portable terminal device 11 and the terminal device 12 of the retail shop 4 to authenticate the client. At this time, the information about the ordered merchandise, the client information, etc. stored in the portable terminal device 11 are transmitted to the terminal device 12. Furthermore, the client information is also transmitted to the authentication organization, and the authentication organization performs the authenticating process (S2011).

The authentication organization performs the authenticating process (S2011), and determines whether or not the user of the portable terminal device 11 is the owner of the device (S2012).

If the authentication organization determines that the third party is using the portable terminal device 11 (NO in S2012), then it transmits a check result that the third party is using the device to the terminal device 12. At this time, the authentication organization stops the function of the portable terminal device 11 (S2013).

The staff of the retail shop 4 who confirms the check result does not provide the merchandise to the client.

On the other hand, if the authentication organization determines that the correct client is using the portable terminal device 11 (YES in S2012), then it transmits an authentication result to the terminal device 12 of the retail shop 4.

A staff of the retail shop 4 confirms the merchandise ordered by the client according to the authentication result and the merchandise information, and provides the merchandise for the client (S2014).

Thus, a third party pretending to be a client can be detected when he or she tries to receive ordered merchandise at the retail shop 4.

If the portable terminal device 11 has the function of paying digital money, and the client pays digital money for the price, the above mentioned authenticating process can be performed. Thus, the pretense by the third party trying to illegal use of digital money can be avoided.

On the other hand, when selected merchandise is purchased at the retail shop 4 (NO in S2002), the client visits the retail shop 4 with the portable terminal device 11, transmits and receives data between the portable terminal device 11 and the terminal device 12 of the retail shop 4 to purchase the merchandise (S2015), and receives an authentication check. At this time, the information about the client stored in the portable terminal device 11 is transmitted to the terminal device 12, and then to the authentication organization. The authentication organization performs the authenticating process (S2016).

The authentication organization performs an authenticating process (S2016), and determines whether or not the user of the portable terminal device 11 is the owner of the device (S2017).

If the authentication organization determines that the user is not the owner of the portable terminal device 11 (NO in S2017), then it transmits the check result that the user is not the owner to the terminal device 12 of the retail shop 4. At this time, the authentication organization stops the function of the portable terminal device 11 (S2018)

When the staff of the retail shop 4 confirms this, he or she does not sell the merchandise to the client.

On the other hand, when the authentication organization determines that the user of the portable terminal device 11 is the owner of the device (YES in S2017), it transmits the authentication result to the terminal device 12 of the retail shop 4.

Upon receipt of the authentication result, the terminal device 12 transmits and receives data to and from the portable terminal device 11, and receives the merchandise information from the portable terminal device 11. If the portable terminal device 11 has the function of paying digital money and the client pays digital money for the price, the above mentioned merchandise information is to be received when the payment is made (S2019).

When the terminal device 12 receives the authentication result, the merchandise information, and, for example, digital money (S2020), the staff of the retail shop 4 allows the client to buy the merchandise, and actually sells the merchandise to the client.

Thus, the pretense, that is, the third party trying to purchase merchandise at the retail shop 4, can be avoided.

Described below is the authenticating process.

It is assumed that the portable terminal device 11 comprises a transmitting unit for transmitting an electric wave for detection of the location when the power is turned on. The electric wave is finally transmitted to a radio communications base station through a relay station, etc., and the radio communications base station detects the position of the portable terminal device 11. The position can be detected using a GPS (global positioning system), a PHS, etc.

Thus, the commerce out-sourcing center 1 can continuously monitor the position of the portable terminal device 11 by continuously obtaining the position of the portable terminal device 11 detected by the radio communications base station.

Additionally, the portable terminal device 11 further comprises a living information input unit for inputting living information, and a living information output unit for outputting the living information to the authentication organization.

According to the present embodiment, the authenticating process can be performed using the portable terminal device 11.

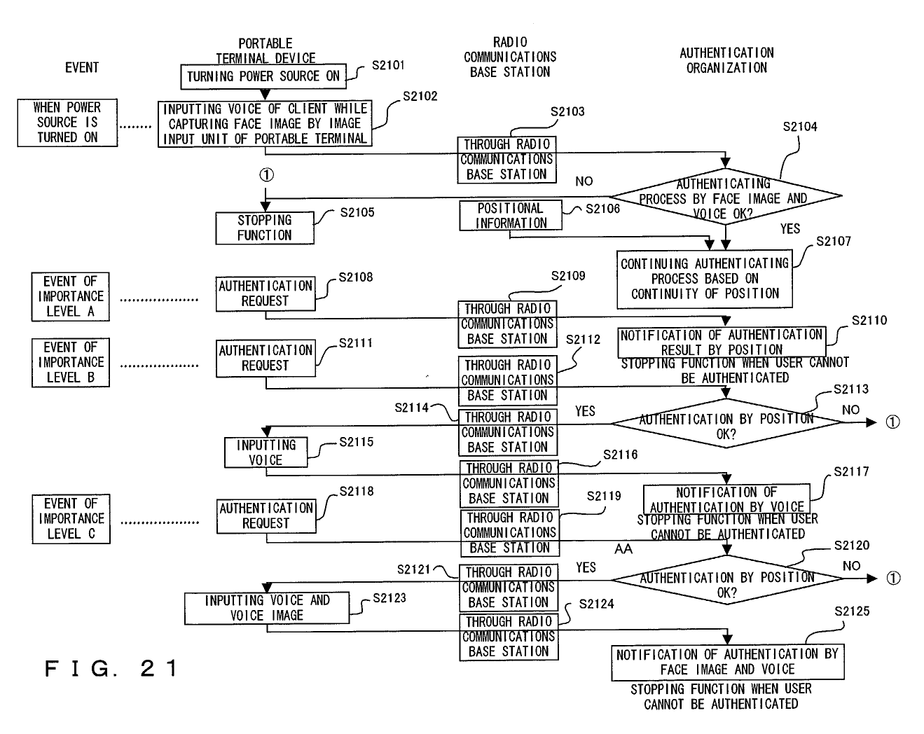

FIG. 21 is a flowchart of the authenticating process according to the present embodiment.

Described below first is the authenticating process performed when the power source of the portable terminal device 11 is turned on. As shown in FIG. 21, when the power source of the portable terminal device 11 is turned on (S2101), the portable terminal device 11 prompts the owner (client) for the living information. At the prompt, the owner inputs his or her own face image and voice as the living information. A living information input unit comprises an image input unit, a voice input unit, etc. The face image is input through the image input unit, and the voice is input through the voice input unit (S2102).

The input living information is immediately transmitted together with the client identification number entered in advance in the portable terminal device 11 to the authentication organization through the radio communications base station (S2103).

On the other hand, the authentication organization stores in advance a client identification number identifying an owner associated with the living information about the owner. Therefore, based on the client identification number, the living information of the client can be designated. The living information contains face image information, voice information, etc.

Upon receipt of the living information and client identification number transmitted from the portable terminal device 11, the authentication organization specifies based on the received client identification number the corresponding living information in the living information set entered in advance, compares the specified living information with the living information received from the portable terminal device 11, and performs an authenticating process to check the user of the portable terminal device 11 is the owner of the device (S2104). If the specified living information does not match the living information received from the portable terminal device 11, it determines that the user is not the owner of the device (NO in S2104), and stops the function of the portable terminal device 11 (S2105).

If the specified living information matches the living information received from the portable terminal device 11, then the authentication organization determines that the user is the owner of the portable terminal device 11 (YES in S2014), starts monitoring the positional information about the portable terminal device 11, and associates the positional information with the client identification number. The positional information is obtained from the radio communications base station (S2106). Subsequently, the authentication organization continuously monitors the positional information about the portable terminal device 11 while the power source of the portable terminal device 11 is set ON (S2107).

Thus, each time the power source of the portable terminal device 11 is turned on, the authenticating process is performed using living information, thereby successfully avoiding the pretense and illegal use of the portable terminal device 11.

When the client is authenticated, the authentication organization associates the living information received from the portable terminal device 11 as the latest living information with the client identification number of the client and reenters the living information, thereby updating the living information entered in advance.

Described next is the authenticating process performed when an authentication request is received while the power source is supplied to the portable terminal device 11. According to the present embodiment, a different authenticating process is performed depending on the importance level of the authentication. That is, the authenticating processes at the importance levels A (low level), B (intermediate level) and C (high level) are performed depending on the importance level of the authentication. The importance level of the authentication is determined based on, for example, the price of purchased merchandise, the time required to perform a requested authenticating process, etc.

Described first is the authenticating process at the importance level A. In this process, the portable terminal device 11a is to perform the authenticating process at the importance level A.

When the portable terminal device 11a issues an authentication request at the importance level A (S2108), a client identification number is transmitted from the portable terminal device 11a to the authentication organization through the radio communications base station (S2109).

Based on the client identification number received from the portable terminal device 11a which issued the authentication request, the authentication organization confirms the already associated positional information about the portable terminal device 11.

At this time, the authentication organization also obtains from the radio communications base station the positional information about the portable terminal device 11a which issued the authentication request.

Then, it compares the positional information about the portable terminal device 11 obtained using the client identification number with the positional information about the portable terminal device 11a which issued the authentication request. If these pieces of positional information match each other, it determines that the portable terminal device 11a which issued the authentication request is the same as the portable terminal device 11 confirmed by the client identification number. Then, according to the history of the positional information about the portable terminal device 11a (11), the continuity of the position is determined. That is, if the continuity of the position is recognized with a small amount of positional movement per unit time, the user is authenticated. If the continuity of the position is not recognized with a large amount of positional movement per unit time, the user is not authenticated. If the continuity of the position is not recognized, it is possible that the third party away from the client turns on the power source of another portable terminal device 11 by illegally using the client identification number when the client turns off the power source of the portable terminal device 11.

However, if the continuity of the positional information is recognized, and the client issues an authentication request when he or she gets on moving means having a large amount of movement per unit time, for example, an airplane, etc., then it is possible that the client cannot be authenticated. In this case, the client notifies the authentication organization of the type of the current moving means, and the authentication organization sets the amount of positional movement per unit time large in determining the continuity so that the client cannot be mistakenly recognized as an illegal user.

On the other hand, if the positional information about the portable terminal device 11 obtained using the client identification number does not match the positional information about the portable terminal device 11a which issued the authentication request, then it is determined that the portable terminal device 11a which issued the authentication request is different from the portable terminal device 11 obtained from the client identification number, and that the user is not authenticated, and the function of the portable terminal device 11a which issued the authentication request can be stopped.

The authentication organization transmits the obtained authentication result to a target which requires the authentication, for example, an Internet shop, etc. (S2110).

Thus, the third party pretending to be a right client can be detected when he or she illegally tries to use the client identification number and pretends to be a client to issue an authentication request.

Described below is the authenticating process at the importance level B. In this process, the portable terminal device 11b is to perform the authenticating process at the importance level B.

When the portable terminal device 11b issues an authentication request at the importance level B (S2111), a client identification number is transmitted from the portable terminal device 11b to the authentication organization through the radio communications base station (S2112). Based on the client identification number received from the portable terminal device 11b which issued the authentication request, the authentication organization performs the authenticating process at the importance level A first (S2113). If the user can be successfully authenticated (YES in S2113), then the authentication organization transmits to the portable terminal device 11b through the radio communications base station (S2114) the instruction information to prompt the owner for voice input.

Upon receipt of the instruction information, the portable terminal device 11b instructs the owner to input voice into the portable terminal device 11b. At the instruction, the owner inputs his or her voice (S2115). When the voice is input into the voice input unit, the portable terminal device 11b transmits the voice as voice information to the authentication organization through the radio communications base station (S2116).

Upon receipt of the voice information, the authentication organization specifies the voice information entered in the authentication organization in advance based on the client identification number received before, compares the specified voice information with the received voice information, and checks the authentication of the client.

If the voice information designated according to the client identification number matches the voice information transmitted from the portable terminal device 11b which issued the authentication request, then it is determined that the right client is using the portable terminal device 11b, thereby authenticating the client.

On the other hand, if the voice information does not match each other, it is determined that the third party is using the portable terminal device 11b which issued the authentication request, the user cannot be authenticated, and the function of the portable terminal device 11b which issued the authentication request can be stopped.

Then, the authentication organization transmits the obtained authentication result to a target, for example, an Internet shop, etc. which requires the authentication (S2117).

Thus, in the authenticating process at the importance level B, the third party pretending to be a right client can be detected when he or she illegally uses the portable terminal device 11 and issues an authentication request through the portable terminal device 11.

Described below is the authenticating process at the importance level C.

In this process, the portable terminal device 11c is to perform the authenticating process at the importance level C.

When the portable terminal device 11c issues an authentication request at the importance level C (S2118), a client identification number is transmitted from the portable terminal device 11c to the authentication organization through the radio communications base station (S2119).

Upon receipt of the client identification number received from the portable terminal device 11c which issued the authentication request, the authentication organization performs the authenticating process at the importance level A first (S2120). If the user can be successfully authenticated (YES in S2120), then the authentication organization transmits to the portable terminal device 11c through the radio communications base station (S2121) the instruction information to prompt the owner for voice and face image.

Upon receipt of the instruction information, the portable terminal device 11c instructs the owner to input voice and a face image into the portable terminal device 11c. At the instruction, the owner inputs his or her voice and a face image (S2123). When the voice is input into the voice input unit and the face image is input into the image input unit, the portable terminal device 11c transmits the voice as voice information and the face image as face image information to the authentication organization through the radio communications base station (S2124).

Upon receipt of the voice information and the face image information, the authentication organization specifies the voice information and the face image information entered in the authentication organization in advance based on the client identification number received before, compares the specified voice information and the face image information with the received voice information and face image information, and checks the authentication of the client.

If the voice information and the face image information designated according to the client identification number match the voice information and the face image information transmitted from the portable terminal device 11c which issued the authentication request, then it is determined that the right client is using the portable terminal device 11, thereby authenticating the client.

On the other hand, if the voice information and the face image information do not match each other, it is determined that the third party is using the portable terminal device 11c which issued the authentication request, the user cannot be authenticated, and the function of the portable terminal device 11c which issued the authentication request can be stopped.

Then, the authentication organization transmits the obtained authentication result to a target, for example, an Internet shop, etc. which requires the authentication (S2125).

Thus, in the authenticating process at the importance level C, the third party pretending to be a right client can be detected because a face image is checked when he or she illegally uses the portable terminal device 11, issues an authentication request through the portable terminal device 11, and inputs, for example, the recorded voice of the right client when a voice input instruction is issued.

In the above mentioned authenticating processes at the importance levels A, B, and C, an authenticating process at a different importance level can be performed as necessary during any of the above mentioned authenticating processes.

As authentication means, a face animation image can be used instead of a face image in a comparing process. In this method, the third party pretending to be a right client can be detected when he or she inputs a photograph of the right client.

However, communications using animation data process a large volume of data. Therefore, for example, the portable terminal device 11 can obtain the next face image when the expression on the face changes from the initial face image so that the obtained face images can smoothly change. After continuously obtaining the face images, they are transmitted to the authentication organization. Thus, the amount of data in the communications can be reduced as compared with the communications using normal animation data. Furthermore, the third party pretending to be a right client by inputting a plurality of photographs of the right client can be detected without fail.

As other authentication means, animation data of a face and voice are transmitted from the portable terminal device 11 to the authentication organization, the authentication organization determines whether or not the movement of the mouth of the animation picture of the face is synchronous with the voice in the received animation data of the face and voice. If they are synchronous with each other, the user can be authenticated.

Thus, the pretense of the third party who inputs the recorded voice can be detected.

At this time, if the animation picture of the face transmitted from the portable terminal device 11 to the authentication organization is limited to the animation around the mouth area, the amount of data in the communications can be reduced. Furthermore, the animation picture around the mouth area can be limited to the animation of the outline of the mouth, then the amount of data in the communications can be further reduced.

Furthermore, assuming that a person threatens a client to issue an authentication request, the authentication organization enters in advance the living information about the client changing by the mental fluctuation (fear, etc.), and determines according to the living information whether or not there is fear (threatening) appearing in the animation information about the face of the client and the voice information transmitted from the portable terminal device 11.

If the authentication organization determines that there is fear appearing in the living information transmitted from the portable terminal device 11, it determines that the client is threatened to issue an authentication request by the third party, and notifies an external public peace and order maintaining organization of the fact, and takes predetermined action on the third party in the designated position according to the positional information about the portable terminal device 11.

The method of determining the emotion such as fear, etc. of a person according to the animation information about the face and the voice information is disclosed through Internet by, for example, ‘Method of Determining Emotion of Person according to Animation Information about Face’ (Takeshi Kunihiro, Hiroshi Shimoda, Hidekazu Yoshikawa of Graduate School of Kyoto University, Energy Science Study Course). The method of determining the emotion of a person according to the voice information has been developed as a product of psychological analysis software, etc., and is used by banks, credit companies, etc.

Living information to be compared when an authenticating process is performed can be the irises, retina, fingerprints, etc.

According to the present embodiment, the information transmitted from the portable terminal device 11 when an authenticating process is performed can be encrypted and then transmitted.

The above mentioned authentication can be performed when a client connects the portable terminal device 11 to a personal computer for connection to an Internet provider and to Internet 7.

As described above, according to the present embodiment, the pretense by the third party can be avoided by performing the above mentioned authenticating processes when a client purchases merchandise through Internet 7 or at the retail shop 4, when the client receives the merchandise at the retail shop 4, etc.

As described above in detail, according to the present invention, the commerce information can be distributed among media and companies by collectively managing the commerce information which has been independently distributed for each media and company. Furthermore, since the taste of each client can be obtained in detail according to the well-managed commerce information, more effective advertising can be realized, thereby realizing more effective commerce.

What is claimed is:

1. A commerce information managing method, comprising:
receiving a request to generate a CM broadcast and CM information relating to the CM broadcast from at least one of a merchandise producer and a service provider;
requesting to broadcast the CM broadcast and the CM information relating to the CM broadcast generated according to the commerce information; and
receiving the CM broadcast designation information designating at least the CM broadcast as the commerce information when a client sees the CM broadcast and purchases merchandise or a service according to the CM information relating to the CM broadcast.

2. The method according to claim 1, wherein
said CM information contains at least one of a merchandise catalog, a merchandise guide book in which merchandise is classified based on a characteristic of each piece of merchandise, a merchandise purchase support page supporting purchase of merchandise based on the merchandise guide book, a service catalog, a service guide book in which a service is classified based on a characteristic of each service, and a service purchase support page supporting purchase of a service based on the service guide book.

3. The method according to claim 2, wherein:
said CM information is described in an XML data format; and
specific information contained in the CM information is distributed.

4. The method according to claim 1, wherein
a broadcast program for broadcasting the CM broadcast and the CM information relating to the CM broadcast is bought from the broadcasting station.

5. The method according to claim 4, wherein
said broadcast program is changed based on at least one of merchandise inventory information about the merchandise producer and service providing information about the service provider.

6. The method according to claim 1, further comprising:
analyzing data of the managed commerce information; and
transmitting an analysis result to the merchandise producer or the service provider.

7. The method according to claim 1, wherein
said commerce information contains any of information relating to merchandise or a service, attribute data of the client, and information about merchandise or a service purchased by the client.

8. The method according to claim 1, further comprising
distributing instructions about merchandise or a service generated by the merchandise producer or the service provider to a shop at which a client receives merchandise or a service so that the client can receive a support of aftercare for the merchandise or the service.

9. The method according to claim 1, further comprising
assigning the client a service point based on the CM broadcast designation information, information about merchandise or a service purchased by the client, and attribute data of the client.

10. A method for offering to purchase merchandise or a service, comprising:
receiving CM information relating to a CM broadcast through a broadcasting station generated by a commerce out-sourcing center receiving a request from at least one of a merchandise producer and a service provider according to a commerce information managed by the commerce out-sourcing center;
offering to purchase merchandise or a service according to the CM information relating to the CM broadcast; and
transmitting CM broadcast designation information designating at least the CM broadcast as commerce information to the commerce outsourcing center.

11. The method according to claim 10, wherein
said CM broadcast designation information is transmitted through Internet or a communication line from a client home or a shop where a transmitting terminal is provided.

12. The method according to claim 10, wherein
when a client purchases merchandise or a service according to the CM information, an authenticating process is performed by an authentication organization.

13. The method according to claim 12, wherein:
said client owns a terminal; and
said authentication organization continuously obtains positional information about the terminal, and performs an authenticating process by comparing positional information about the terminal obtained when the authenticating process is performed with continuously obtained positional information about the terminal.

14. The method according to claim 12, wherein:
said client owns a terminal;
said terminal comprises:
an identifier identifying a person; and
a living information obtaining unit obtaining living information;
said authentication organization comprises living information of the person associated with the identifier;
when an authenticating process is performed by said authentication organization, said terminal transmits the identifier and the living information obtained by said living information obtaining unit to the authentication organization; and
said authentication organization designates living information associated with the identifier based on the identifier received from said terminal, performs a authenticating process by comparing the designated living information with the living information transmitted from the terminal, and transmits a result of the authenticating process to a target which requires the result.

15. The method according to claim 14, wherein
said authentication organization further comprises an emotion estimation unit for estimating emotion from the living information received from the terminal, and notifies a public peace and order maintaining organization when the living information indicates fear based on estimation of emotion according to the living information by said emotion estimation unit.

16. The method according to claim 14, wherein
said living information is voice information, face image information, or face animation information.

17. The method according to claim 14, wherein
said living information is a plurality of face images indicating different expressions obtained when an expression of a face changes.

18. The method according to claim 14, wherein:
said living information obtained by said living information obtaining unit is voice information and animation information about a mouth portion of a face;
when said authentication organization performs an authenticating process;
said terminal transmits the voice information and the animation information about the mouth portion obtained by said living information obtaining unit to the authentication organization; and
said authentication organization performs an authenticating process based on the voice information and the animation information about the mouth portion transmitted from the terminal, checks synchronization between the mouth portion and the voice, and transmits a result of the authenticating process to a target which requires the result.

19. The method according to claim 18, wherein:
said terminal further comprises an outline information obtaining unit outputting animation information only about an outline of a mouth portion from the animation information about the mouth portion obtained from said living information obtaining unit;
when said authentication organization performs an authenticating process, said terminal transmits the voice information and the animation information only about the outline of the mouth portion; and
the authentication organization performs an authenticating process based on the voice information and the animation information only about the outline of the mouth portion transmitted from the terminal, checks synchronization between the mouth portion and the voice.

20. The method according to claim 13, wherein
said authentication organization does not authenticate a user when determining that an amount of position movement per unit time of the terminal is large according to continuously obtained positional information about the terminal, and there is no continuity of the position.

21. The method according to claim 20 wherein:
said terminal transmits a type of transportation input by an owner to the authentication organization; and
based on the type of the transportation, said authentication organization changes an amount of position movement based on which it is determined that there is no continuity of the position.

22. The method according to claim 15, wherein
said living information according to which emotion is estimated by said emotion estimation unit is face image information.

23. The method according to claim 15, wherein
said living information according to which emotion is estimated by said emotion estimation unit is voice information.

24. The method according to claim 10, further comprising
transmitting information about the merchandise or service purchased by a client, and attribute data of the client with CM broadcast designation information.

25. The method according to claim 24, wherein
when said client purchases merchandise or a service, the client place an order at an Internet shop.

26. The method according to claim 13, wherein
said authentication organization performs an authenticating process according to continuously obtained positional information about the terminal when a plurality of terminals having the same identification numbers appear in a unit time.

27. A commerce information distribution system, comprising:
a commerce out-sourcing center having a computer for managing commerce information for receiving a request to generate a CM broadcast and CM information relating to the CM broadcast from at least one of a merchandise producer and a service provider;
a broadcasting station broadcasting the CM broadcast and the CM information relating to the CM broadcast generated according to the commerce information; and
a terminal transmitting CM broadcast designation information designating at least the CM broadcast as commerce information to the commerce out-sourcing center when a client sees the CM broadcast and purchases merchandise or a service according to the CM information relating to the CM broadcast.

28. A commerce information management apparatus, comprising:
a CM information generation unit generating a CM broadcast and CM information relating to the CM broadcast according to managed commerce information after receiving a request from a merchandise producer or a service provider;
a request unit requesting a broadcasting station to broadcast the CM broadcast and the CM information relating to the CM broadcast; and
a management unit receiving CM broadcast designation information designating at least a CM broadcast seen by a client from a terminal used by the client when the client purchases merchandise or a service according to the CM information relating to the CM broadcast after the client sees the CM broadcast, and managing the CM broadcast designation information as the commerce information.

29. A commerce information management apparatus, comprising:
a first reception unit receiving information about merchandise or a service upon receipt of a request from a merchandise producer or a service provider;
a second reception unit receiving information about a client or CM information about merchandise or a service as commerce information when the client purchases the merchandise or the service; and
a management unit collectively managing the commerce information.
